(19) United States
(12) Patent Application Publication
(10) Pub. No.: US 2008/0207327 A1
(43) Pub. Date: Aug. 28, 2008

(54) Virtual Environment with Alerts

(75) Inventors: Andrew S. Van Luchene, Santa Fe, NM (US); Raymond J. Mueller, Palm Beach Gardens, FL (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/676,848

(22) Filed: Feb. 20, 2007

(51) Int. Cl. G06F 17/00

(52) U.S. Cl. 463/42

(57) ABSTRACT

A virtual environment in which players are able to receive alerts intended to indicate the occurrence of a given event within the virtual environment. The alerts may be delivered to the player while he is playing the game via an in-game messaging service or other similar device. Alternatively the alerts may be delivered to the player via a real world communication device such as a cell phone, pager, text messaging device, or the like.

### BACKGROUND

Video games which are accessible to multiple players via a server or peer to peer network are well known. For example, hundreds of thousands of players access games known as massive multi-player online games (MMOGs) and massive multi-player online role playing games (MMORPGs). Players of these games customarily access a game repeatedly (for durations typically ranging from a few minutes to several days) over a given period of time, which may be days, weeks, months or even years. The games are often constructed such that players pay a periodic subscription price (e.g., $15 per month) rather than, or in addition to, paying a one time purchase price for the game. Often, though not necessarily, these games have no ultimate “winner” or “winning goal,” but instead attempt to create an enjoyable playing environment and a strong player community.

It would be advantageous to provide improved methods and apparatus for increasing the enjoyment and/or longevity of video games including, but not necessarily limited to MMOGs and MMORPGs.

### BRIEF DESCRIPTION OF THE DRAWINGS

FIG. 1 is a block diagram depicting a network according to an embodiment of the present disclosure.

### DETAILED DESCRIPTION

### Definitions

Unless stated to the contrary, for the purposes of the present disclosure, the following terms shall have the following definitions:

Virtual Purchase Total may include the total virtual cash or cash equivalent needed to purchase a virtual item or attribute at or from a virtual shop or bank in a MMPOG.

Virtual Taxes may include a percentage, flat fee or combination of percentage/flat fee applied to activity in a virtual world or massive multiplayer online game.

Virtual Title may include a software module or application or any portion thereof and/or a record in a database that indicates, stores, tracks or otherwise documents the virtual owner or owners of one or more virtual items. In an embodiment, c. Characters cannot use a virtual item unless they are first registered on the virtual title. A fee can be paid to transfer title of the item to another character.

Virtual Activity may include any activity of a player or player character that can be measured by the game server or other application.

Notification methods may include but are not limited to:
a. Email message
b. Telephone or cell phone
c. Instant Message
d. Text Message
e. Physical Mail
f. Writing a record or entry to a file or database
g. Voice mail message
h. Pager
i. Graphic, text or audio message delivered by the game on screen to the receiving player and/or delivered by another character, or NPC
j. Any combination of any of the above.

Alert may include the transfer or storage of information or otherwise communicating with, by, between or among any two or more of the following, including, but not limited to any real or virtual: a) players, b) game owners, c) game or other servers, d) player characters, e) NPC's, f) exchanges, g) game devices or controllers, h) cell phone or other communications hardware and/or networks, i) databases, j) software applications, k) legal agencies, l) governing bodies, m) software interfaces, n) and/or any combination of any of the above, which may be initiated by and/or based upon an alert event or other action.

Alert Event may include any change in, of or to any condition or state, and includes any action, opposite action, unexpected action, desire for action, or failure to act, and thus Alert Event includes, but is not limited to any one or more of:
1. When or after any one or more variables or data changes or is expected or is about to change within a game application, service, API, communications network or one or more databases, or database variables or element, e.g., a balance is reached or exceeded, including, but not limited to:
   a. time a player or character account has been active or inactive
   b. number of complaints or compliments by other players/characters for a given player/character
   c. amount of time and/or quality and/or number of times a player or player character has provided assistance or other help or tutelage to another player and/or player character
   d. amount of time and/or quality and/or number of times a player or player character spends managing, directing or otherwise controlling one or more NPC's
   e. attributes and virtual assets or debts of the player/character
   f. player or character total or frequency of purchases of virtual cash outside or within the game environment
   g. number of loans and contracts that the character has outstanding and/or their balances
   h. payment history and timeliness of payments for any loans or other payment obligations, e.g., tax or other fee payment history
   i. guild or family of the player or character
   j. number of times the character has defaulted or paid timely on a loan or other contract
   k. age of the player account
   l. age of the player
   m. real world credit scores, points, creditworthiness or payment history
   n. experience level of the player or one or more of his characters
   o. annual income of the player or one or more of his character
   p. payment history of the character
   q. production level of the character, e.g., ability or historical performance in producing objects within the game
   r. Current assets or liabilities, e.g., net worth of a player character
   s. The number of active characters in a player account
   t. The size of the character's guild or family in the game environment
   u. The age of the account of the player
   v. The virtual transaction volume of the character or player
   w. Membership status of the character, e.g., premium member vs. basic member of the video game or credit card holder status, e.g., gold or platinum members
   x. Age of the video game or credit card account,
   y. Killing monsters in a game environment
   z. Joining a Guild in a game environment
   aa. Completing a quest in a game environment
   bb. Solving or completed a game parameter in a game environment
   cc. Paying a bill timely
   dd. Failure to pay a bill when due
   ee. Randomly
   ff. Any activity or outcome or expected or desired or undesirable outcome within the game or associated with the player's and/or the any one or more of the player character's financial condition (real or virtual) and/or the credit card(s) and/or credit line(s)
   gg. How many times the player or player character requests credit or such credit is checked or held or is otherwise encumbered
   hh. A range of amounts or values or reaching or falling below a threshold associated with any of the above (as appropriate)
   ii. When or after information is transmitted and/or shared (e.g. via a communications package or other mechanism) between two or more applications, game services, servers, financial institutions, or any other entities, e.g., a message sent between two servers to settle a debt or payment.
   jj. When or after a step or procedure (e.g., of software, a script, a user-defined process) is executed, e.g. when a penalty or interest amount is charged to an account, or an action is taken by or within a game.
   kk. When or after an application or service (e.g., a software service) is started, paused, stopped, proceeds to a certain point, or is changed.
   ll. When or after an item becomes or may become available for use or sale by an NPC or Player Character and/or at any given point during construction of the item, e.g., at a construction milestone.
   mm. When or after a character has reached or may reach a certain level or has started and/or completed a certain mission or game objective or goal within a mission.
   nn. When or after a player has obtained or may obtain or fails to obtain a certain attribute or resource.
   oo. When or after a player is logged into or out of the game or another participating game, e.g., when a friend logs into a particular game, and/or when a player remains logged in or out for a given period of time.
   pp. When or after a character or NPC has been created, modified, harmed, killed or destroyed in a game, and/or some other action is taken by or otherwise affects or should have affected one or more player or player characters.
   qq. When or after a player's account or any attribute of any player character is and/or any of his financial data or other information that may be or should have been changed, added to or removed, lost or damaged.
   rr. When or after a price, fee, tax, or other financial amount changes or should have changed (e.g., increases or decreases or is established or eliminated, or is expected, calculated or projected to change).
   ss. A trend changes or should or should not have changed or is expected to change, e.g., a particular rate of spending increases or decreases.
   tt. A battle or wager is or should or should not have or is expected to be started, won or lost, or an interim objective is achieved or is not achieved.
   uu. An object or service should or should not be or is made available for sale or the price changes or is about to or is otherwise expected to change.
   vv. A marketing offer should or should not be or is generated, determined or presented.
   ww. A player should or should not or otherwise joins or retires from a game.
   xx. A player fails to or completes a task, level, challenge, duty, service, mission, etc.
   yy. A new game or version of an existing game should or should not be or is brought online or offline or is available or not available for play.
   zz. A game should or should not be or is or is expected to be turned off for servicing or is no longer available for play (temporarily or permanently, to some, certain or all players).
   aaa. A tax amount or rate should be, should not be or is created, changed, deleted, reached, falls below or increased or decreased by an amount or percentage or may soon change or is expected to change.
   bbb. An item or object is expected to and/or should or should not be or is otherwise identified, stolen, found, created, bought, sold, encumbered, used, deployed, returned, compromised, modified or destroyed.
   ccc. One more players and/or servers and/or applications wishes, determines or requests or should or expected to wish, determine or request to notify another one or more players and/or servers and/or applications via an alert message or messages and/or when or if a player responds or fails (or should fail) to respond to an alert.
   ddd. When a player is expected or should or should not be or is logged in to a system (e.g., the virtual world, an external instant messenger system).
   eee. When a date and/or time approaches, is reached or is past.
   fff. When a virtual auction should or should not or does start or is ending or has ended.
   ggg. When an item within a virtual auction should or should not or does come up for bid or has been sold or has not been sold.
   hhh. When payment is made or is or will, or should or should not become due for a virtual purchase or on any loan and/or when one or more payments are missed, or based upon a payment term, condition or type.
   iii. When a loan penalty or interest is or should or should not be applied.
   jjj. When or after a reward or point should or should not be or is assigned to a financial account or when or after a certain threshold is or should or should not be reached, e.g., when a player accrues sufficient points to purchase a desired item.
   kkk. When a player should or should not or is expected or otherwise opens, closes or applies for a loan and/or makes or fails to make a payment on a loan and/or makes the wrong or unexpected payment on a loan.
   lll. When the credit score, credit history or risk profile of a player or player character is updated or changed or changed a certain percentage.
   mmm. When or after one or more player characters, NPC's or any other real or virtual person or item moves from one (real or virtual) position to another, or from one position to a specific position, or plans to use, applies for, is expected to use or fail to use, or uses one path vs. an expected or required path, or deviates from one path to another path, or proceeds faster or slower than required or expected or not at all.
   nnn. The negative or opposite of any one or more of the forgoing.
   ooo. A partial occurrence or greater occurrence or outcome of any one or more of the forgoing.
   ppp. A change in the rate or frequency of any one or more of the forgoing.
   qqq. And/or any one or more or any combination of any of the above, which are collectively referred to as an “alert event”.

Credit Card—a credit instrument issued by a real or virtual world institution to a player that allows the player to make purchases by providing an account identifier (e.g. a credit card number) rather than cash or other currency. An example is a credit card like those issued by Visa, MasterCard, or American Express. For the purposes of the present disclosure, the term “Credit card” is intended in a very broad sense and is not limited to those situations in which a player's purchases are made on credit (i.e. where payments for those purchases is not due until a later time) but also includes financial instruments such as debit cards, check cards, lines of credit and the like.

Virtual credit card—a financial instrument issued in a virtual environment that acts in the virtual environment for virtual currency the way a real world credit card acts in the real world for real currency.

Real Cash Value—the value in real dollars of the virtual currency. This value can be determined by multiplying the value of a virtual currency amount by the current exchange rate to real dollars.

Total virtual obligation amount-the total amount of the virtual financial obligation(s) associated with a player character's account.

Virtual Contract—An enforceable agreement between a first player character and either another player character, a game server, or a third party. Some examples of virtual contracts are provided in U.S. Provisional Patent Application Ser. No. 60/652,036, which is hereby incorporated by reference in its entirety for all purposes.

Virtual—shall mean in a video game environment or other intangible space.

Virtual World—a world created in an online game such as World of Warcraft, or a virtual community such as Second Life, Eve or There.com.

Virtual Creditor-shall mean a first player character or other entity who is owed a virtual obligation by a second player character.

Virtual Credit Score—a score given to player characters in a video game based on one or more of the following criteria: the virtual assets they possess, the age of the character account, the type of account, e.g. basic or premium, the available credit line of the credit card associated with the account, the existing virtual financial obligations of the player character account, the player character's payment history including days to pay, amounts overdue or delinquent, and/or the player character's real world credit score, and/or the factors used in the real world to determine a credit score.

Virtual Financial Account—a virtual account issued to a player character by a virtual bank, game server or third party where virtual cash can be deposited and withdrawn.

Virtual Financial Obligation—An agreement by a player character or entity to pay one or more game attributes to another player character, entity or game server. This obligation can be a one time payment, or multiple payment over time. The obligation can specify that payments are due on virtual or real dates.

Virtual Financial Intermediary—Financial intermediaries are institutions including depository institutions, contractual savings institutions, and investment intermediaries which offer financial products and services for use within the virtual environment. The various financial intermediaries available in the virtual environment may each serve different or overlapping purposes and provide means for using, saving, borrowing and transferring currency.

Virtual Financial Obligation Value—the in game value of the obligation. For virtual cash the value may be stated as a virtual and/or real cash amount. For other game attributes, the value can be determined by generating a virtual cash market value for the item based on the current value in an online marketplace or exchange. The value of the obligation may be fixed or variable and may also be set as a condition of the player contract and/or by the game server or other entity.

Billing Information—shall mean any information pertaining to billing a player for playing a game, accessing a game, purchasing goods or services, or any other reasons. Billing information may include such real world information as a billing address, credit card account number, bank account number, pay pal account number or other payment facilitator, or the account number of any other financial entity providing a real world credit line or any other payment-related information.

Character or “player character”—a persona created and controlled by a player in a video game.

Avatar—the virtual representation of a player character.

Character Account—an account that tracks character attributes.

Character Attribute—any quality, trait, feature or characteristic a particular Character can have that is stored in the corresponding Character Account. Character Attributes may include, but are not be limited to:
1. A character score
2. A virtual object
3. The physical appearance of a character
4. An emblem or mark
5. A synthetic voice
6. Virtual currency
7. Virtual help points or credits
8. The ability to join groups of other players at a later time
9. A score for subsequent matching of later game parameters
10. A relationship with another character
11. A genetic profile or makeup
12. A skill or skill level
13. A ranking

Character Life—a fixed or variable, finite or infinite period of virtual or real world time that a player character can exist in a game environment.

Character Skills—game attributes inherent in or acquired by a player character during game play such as, but not limited to: the ability to cast (certain) spells, foretell the future, read minds, use (certain) weapons, cook, hunt, find herbs, assemble herbs into potions, mine, assemble objects into other objects, fly, and/or enchant other player characters.

Computer Generated (CGC) or Non-Player (NPC) Character—any character that is controlled by the game system and/or a computer program and/or rules established by the game system and/or a player and not by a player on a continuous basis.

Game performance parameter—any aspect of a Video Game by which a player character's performance can be measured. Game Parameters shall include, but not be limited to:
1. Completing all or part of a mission
2. Playing for a certain period of time
3. Winning a match against another player character or computer generated character
4. Reaching a certain level or score
5. using or obtaining an ability or technology
6. kill/death ratios
7. obtaining, creating or modifying an object
8. solving a puzzle
9. accuracy with weapons
10. effective use of the proper weapon
11. killing a certain character/creature
12. getting through or to a certain geographic area
13. decreasing or increasing Karma Points
14. getting, buying, exchanging or learning a new skill or player attribute
15. having a child
16. getting married
17. obtaining, buying, trading, producing or developing raw materials
18. producing goods or services
19. earning income
20. earning a higher rank in an army
21. winning an election among two or more player characters
22. achieving deity or other status
23. improving player character status or caste
24. assisting other player characters with any of the above
25. speed of accomplishing or changing the rate or trends of any or all of the above.

In-game Marketplace—shall mean a virtual environment where Characters can exchange items, attributes, or any other exchangeable game element.

Novice Player—shall mean a player that is identified as requiring the help of an expert to complete a Game Parameter.

Player—shall mean an individual who can register an account with a Video Game Central Server or within a peer-to-peer network and create Characters that can interact with other Characters in a Virtual Environment, and/or that can authorize a NPC to act on the player's behalf.

Player Account—shall mean an account on the Video Game Central Server or within a peer-to-peer network that contains a Player profile including personal, billing, and character account information.

Player Attribute—shall mean any attribute that can be applied to a player account. Player Attributes shall include, but not be limited to:
1. Real Currency.
2. Discount of monthly fees for playing game.
3. Monthly fee for playing a game.
4. Interest rates for use of or borrowing real or virtual cash amounts.
5. Global character attribute settings for all characters created by player across multiple games.
6. Rewards for encouraging another player to signup to play.

Player to Player Contract—a real and/or virtual but binding contract between player characters that allows the players to provide or exchange game attributes to one another. Once a player-to-player contract is established, the game server or peer-to-peer network automatically distributes acquired game attributes between the player characters based on the contract conditions.

Video Game—a game played on a Video Game Consul that may or may not be networked to a Video Game Central Server or within a peer-to-peer network.

Video Game Consul—a device comprising a CPU, memory and optional permanent storage residing at a player location that can allow for the playing of video games. Examples include, home PCs, Microsoft Xbox, and Sony Playstation.

Video Game Central Server—a CPU, memory and permanent or temporary storage that is connected to multiple Video Game Consuls that allows for Massive Multi Player Online Video Games to be played.

“Game Environment”—a particular level or area within a virtual world. Each game environment may have its own rules, regulation, currency, government, managers, etc. Game environments may exist within other game environments.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The term “consisting of” and variations thereof mean “including and limited to”, unless expressly specified otherwise.

The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” means one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

### Description

Massive multi player online games (MMOGs) or massive multi-player role-playing games (MMORPGs) are computer game which are capable of supporting hundreds, thousands, or millions of players simultaneously. Typically, this type of game is played in a giant persistent world where the game continues playing regardless of whether or not real players are logged in. Players commonly access these games through a network such as the Internet, and may or may not be required to purchase additional software or hardware in order to play the game. Such networks allow for people all over the world to participate and interact with each other in a virtual environment. The present disclosure provides systems and methods which contribute to the evolution and longevity of such a game.

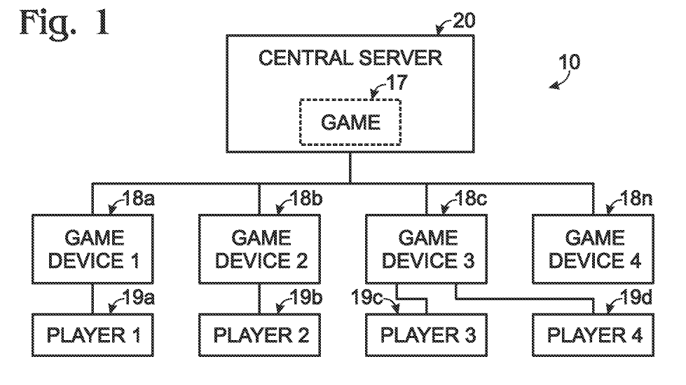

The herein described aspects and drawings illustrate components contained within, or connected with other components that permit play in the virtual environment. It is to be understood that such depicted designs are merely exemplary and that many other designs may be implemented to achieve the same functionality. Any arrangement of components to achieve the same functionality is effectively associated such that the desired functionality is achieved. FIG. 1 provides an exemplary network which may be used to support a virtual environment.

Referring to FIG. 1, a network system 10 according to one embodiment includes a central server 20 in communication with a plurality of video game playing units 18. Those of ordinary skill in the art will appreciate that any number of video game playing units may be in communication with the central server. Typically, the number of video game playing units changes at various times as players join games and as players stop playing games. Similarly, more than one server may operate to coordinate the activities of the video game playing units, as is well known in the art.

Central server 20 may comprise any computing device (e.g., one or more computers) capable of communicating with other computing devices. The server 20 typically comprises a processor which is in communication with a storage device, such as an appropriate combination of RAM, ROM, hard disk, and other well known storage media. Central server 20 may comprise one or more personal computers, web servers, dedicated game servers, video game consoles, any combination of the foregoing, or the like.

Each video game device 18 may comprise any device capable of communicating with central server 20, providing video game information to a player, and transmitting the player's desired actions to the central server. Each video game device typically comprises a processor which is in communication with a storage device, such as an appropriate combination of RAM, ROM, hard disk, and other well known storage media. Suitable video game devices include, but are not limited to, personal computers, video game consoles, mobile phones, and personal data assistants (PDAs).

Some or all of video game 17 can be stored on central server 20. Alternatively, some or all of video game 17 may be stored on the individual video game devices 18. Typically, the video game devices are able to communicate with one another. Such communication may or may not be facilitated by central server 20. Accordingly, a player 19a accessing video game 17 via game device 18a may be able to play with a player 19b accessing video game 17 via game device 18b. As shown, it may be possible for multiple players (e.g. 19c, 19d) to access central server 20 via the same game device (e.g. 18c).

Regardless of whether video game 17 is stored on central server 20 or video game devices 18, server 20 is typically configured to facilitate play of the game between multiple game players.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

According to one embodiment, the present disclosure provides methods and systems to provide access to a massive multi player online game in exchange for monthly virtual cash payments that are secured with a real world credit card. For example, a game provider or third party service charges its players a percentage virtual tax or commission based on some or all of one or more or any combination of the player's: activity, property, assets, skills, account type, family, and/or credit history in the game. This charge may be applied in lieu of or in addition to charging a fixed monthly or other fees to play. For example, Player Characters produce attributes that, when sold (or traded, disposed of or modified), can be taxed by the game environment. Player Characters may also receive income from services or as otherwise provide by or generated within the game, which income may also be taxed by the game. Virtual currency can be converted into real currency using an exchange.

The system tracks activity and charges virtual taxes on that activity. For example, at the end of each month, or any other determined interval(s), the system determines if the taxes collected are adequate to partially or completely offset the monthly or other fees due (if any). In one embodiment, if the virtual taxes collected are adequate, i.e., equal to or greater than the fees due from a given player, the player's account is flagged as having been paid. In another embodiment, any excess fees paid are returned in whole or in part to the player. Conversely, if the virtual taxes are inadequate, a virtual or real currency value is assigned to the virtual tax amount owing and that amount is subtracted from the minimum fee due. The real or virtual currency remainder is then charged to the player's credit card or other financial account on file and/or the player may be notified prior to such charge to permit said player the opportunity to pay the remainder using virtual or real currency and/or to select a credit card or other financial instrument other than the default or registered credit card(s) on file.

In an embodiment, the system may alert one or more players or other entities via use of an alert system. For example, the system might alert a player that an unpaid tax is or will be coming due. In another embodiment, the system might alert a player that he has overpaid his taxes and/or has sufficient excess fees paid to permit the purchase of one or more items from a catalog. Methods for sending such alerts are disclosed in further detail later on in the present disclosure.

Taxes can be calculated, assessed, charged, levied or generated, or virtual credits can be given for any one or more of the following activities, including but not limited to:
1. time, matches, battles, activities or turns played or partially played in the game world and/or between or among multiple video games or other applications
2. creation, modification, use, transfer, disposal or destruction (in part or in whole) loss, theft, and/or registration or creation or transfer or modification of title or other activities involving or related to any tangible or intangible attributes, assets, income, loss, gain, liabilities or items that are acquired, deposited, transferred, disposed of or destroyed (in whole or in part), sold or traded, bartered or otherwise affected in the game world and/or between two or more game worlds or applications, and/or the real world and/or any combination thereof
3. virtual or real currency acquired, generated, counterfeited, deposited, withdrawn, lost, stolen, disposed of or destroyed (in whole or in part), transferred, sold or traded in the game world or between the game and real world, and/or between two or more game worlds or applications or any combination thereof
4. creation, trade, acceptance, disposal, destruction, acquisition, modification, registration, transportation, transferal, loss, theft, storage, expansion, renewals or extensions of any one or more of, including, but not limited to any new or used tangible or intangible attributes, including items, assets, liabilities, performance obligations, currency (real or virtual), avatars, property, life, skills or any abilities, potions, spells, names, clans, families, parents, children, accounts, financial instruments and the like and/or any delivery or acceptance or loss or benefit of or from/to any service.
5. time, matches, battles, activities or turns started, used, completed or missed or partially missed when the player was otherwise required or generally expected to play
6. messages or any communications between two or more players, player characters, NPC's, or information processing services, e.g., news or other information services, cell phone companies, Internet providers, game server owners, the game or games themselves, etc., said communications may be in any form including e-mail, instant, voice or text messages, recordings, data storage, transfers of items, objects, attributes, news stories, video, audio, or any other data or tangible or intangible property, such as data transfer between a player and another player or game to game or between one or more players and one or more games.
7. creating, writing, modifying, or use of any video game or other software application(s), and/or any database or other information contained in any such video game or software application, and/or any communications between two or more video games and/or player characters between two or more video games, video game consuls, or between a video game or player character
8. creation, providing or use of any game servers or game consuls or permission to time spent or access or use of same or any applications or hardware associated with said game servers or consuls.

In addition or in the alternate, any actual revenues (real or virtual) received by individuals, player characters, NPC's, avatars or other entities (whether tangible or intangible), a tax is charged on the part or the entire amount received.

In certain embodiments of the present invention a ceiling or cap may be established to limit the total tax paid for any given transaction and/or over a certain period of time, e.g., a maximum tax amount per turn, hour, day, month or year.

In another embodiment, the taxes are calculated and are not compared with any target or other total tax due or expected, instead or in addition, the game simply charges and collects the taxes based upon any one or more of the methods disclosed herein. In such cases, the amount of taxes collected may be less than, equal to or greater than the fees that may otherwise be charged to a player on a periodic basis, e.g., monthly payment options.

In yet another embodiment, players are given a choice when they sign up as to which payment method they prefer, e.g., via taxes or via fixed or variable monthly fees, or taxes, plus fees, etc., or any combination of these options. In one embodiment, players may not change their preferences after the start of play, while in other cases, players may be given the option to change their payment method once, or more than once. When making such changes, players may or may not be offered the same or similar options and/or such options may be offered but at a different price point than the original offer(s).

Taxes on the virtual or real value of game attributes created, acquired, traded, disposed of and/or sold (or otherwise) by a player can be applied in real or near real-time, on a per session, or other periodic basis, e.g. per turn, hourly, daily, weekly or monthly, such application may be on a “cash” or an “accrual” basis. The system can retrieve a periodic log of all attributes (or any other tangible or intangible item) that are either acquired, created, gathered, traded, disposed or destroyed (in whole or in part), deposited, transferred, bartered, modified, improved, and or sold and apply a tax rate to the attributes to determine a tax value or tax due. In one embodiment, when amounts are due, a credit line may be pinged or held until such amounts are actually paid. In the event the amounts due are not paid, the credit card is charged for all or part of the outstanding amounts due.

Tax rates may be fixed or variable. For example, tax rates may be a fixed percentage for all players regardless of income, or the rates may increase for those at higher income levels, i.e., a progressive tax. In another example, the rates may be fixed for certain transactions, e.g., a sales tax rate of 7% may apply to all sales of goods and/or services, but income tax rates may vary by income, or class, or age, or any other one or more characteristics. In yet another example, sales tax rates may be higher and/or a new or additional tax may be calculated and assessed when or if the business is transacted between two or more game servers or video game applications, with a portion of the tax revenues going to each of the affected game servers or applications or other entities. In another embodiment, rates may be different for salaried income as opposed to a sale of goods or services. Rates may be flat, e.g., 10% at all income levels or progressive, as with the current US tax system. Rates may vary depending upon the age, skill level or other attributes of the player, and/or the player's avatar, clan, ranking, membership level (e.g., gold vs. platinum player), fixed or variable game play rates, e.g., a player that pays a fixed fee of $50 per month to play the video game, may have lower income taxes than a player that pays only $25 per month to play. Taxes may be random, flat, regressive or progressive.

Taxes may change over time, i.e., increase or decrease. Such changes may be determined by any one or more of the following, including, but not limited to: random chance, the game owner, the game software, rules or genetic algorithms, simple majority or super majority vote of two or more players or player characters or NPCs, or other forms of governance, e.g., via a dictator, king, queen, despot, president, governor, tax collector, congress, senate, etc., or any combination of the foregoing, etc. Said changes may be designed to maximize revenues for the game owner, or to maximize or optimize game play, or to encourage or discourage additional players or growth of the game or the game's economy, or to extend or shorten game play, or to enforce rules and regulations or to relax such rules and regulations, or to encourage or retard the growth of part or all the virtual economy and/or inflation or exchange rates of any real or virtual currencies, or other financial instruments and/or to affect the current or expected future value of any one or more of any properties, financial accounts, real estate, assets, liabilities, game or other revenues.

Information and/or Taxes may be reported, distributed and/or shared with or between the game server, owners, players, video games, applications, local governing bodies and/or with any other real or virtual governing body, e.g., any virtual or real world local, State or Federal agency, e.g., the US IRS. Prior to inserting, trading, creating, encumbrance of or otherwise acquiring or disposal or destruction of all or any part of any new or other object, attribute player or player character, or other tangible or intangible item or currency or other financial instrument into a game, the player may be required to divulge the source of the item (including, for example, its title history, etc.) and the amount paid or promised to be paid or other terms and conditions for the item (etc.). This way, deals that may be conducted in whole or in part “outside the virtual space” or without the knowledge or participation of the virtual space, are controlled as if they occurred partially or entirely within the virtual space. In one embodiment, only items that have a verifiable history (i.e., have existed only within the game and/or within other games that support or provide for such tracking, control and history or title) or title are permitted to be acquired, encumbered, traded, sold, used, stolen, transferred, created, bartered, etc., within the system. The system (and/or other compatible systems, e.g., a system that is certified and complies with established rules) could track what each player reports and identify any anomalies, which may be an indicator of fraudulent activities. E.g., most people buying a tank offline (i.e., outside the game environment) are paying $2 each. Then, a player starts logging in new tanks saying he only paid $0.10 or, conversely $20 each. This may not necessarily mean there is fraud, but an investigation is indicated.

In addition or in the alternate, all or some items that are sold or acquired outside of the game must be registered and various information may be recorded, for example, the selling price, time/date of the transaction, names of affected parties, values paid or received and/or other information may be automatically recorded. In addition or alternatively, the game may establish minimum or maximum market values or acceptable ranges for individual, groups or classes of items. Such minimums, maximums or ranges may or may not be based upon actual or reported valuations and/or actual values as determined or witnessed or experienced within the virtual game space. Such valuations may also be adjusted from time to time for no reason or for any one or more of the following reasons (as may be determined by the any one or more of the game owners, developers, the game itself, or by any vote or otherwise agreed upon by either the parties in control of such terms and conditions and/or by those affected by such terms and conditions), including, but not limited to: inflation rates, arbitrary times/amounts, randomly, game GDP growth rates, actual transactions for specific items or classes of items or groups of items, or across all items, taxes, changes in exchange rates, changes in growth rate objectives, by vote (simple majority or super majority) or via votes by an elected body or representatives granted the power and authority to recommend and/or impose such changes, or based upon the last actual selling or purchase or barter price or the highest, lowest, average, weighted average, moving weighted average, or most recent price of the item or any other mathematical calculation imposed by any authorized or governing body, or via any method(s) of calculation including neural nets, genetic algorithms or other statistical methods designed to optimize or otherwise generally control or determine tax rates, methods and other variables, and/or any combination of the forgoing.

All items created in a game can also automatically have a virtual title generated or updated for them. A character may be required to associate his name with the title in order to use (and/or sell, dispose of, barter, create, etc.) the item. A fee for registering the virtual title with the character can be charged to the player character and treated as virtual taxes. In an embodiment, such title tracking system or providence is automated and contained within the game itself. In another embodiment, part or all of such a title system resides outside of the game, but is otherwise in communication with the game. Such communications may be persistent or on a transaction or other periodic basis.

The player can be given the option of paying a monthly fee with “world cash,” or with virtual currency taxed to his characters or account or other authorized entity, e.g., his bank or accounting firm or other third party. In an embodiment, when the player logs in, logs out, or at any other prescribed time(s), a screen notifies him if he has enough tax credits to pay for his monthly fee and/or to continue play. The player can elect to use the credits to pay for his monthly fee, or to save the credits, which can be used for other purposes, such as purchasing items in a catalog. A player may pay any fees when due with real or virtual cash, tax credits, or any combination of these options. In one embodiment, the video game or game server automatically deducts taxes when due from the player's real or virtual financial accounts. In another embodiment, the tax system resides in part or in whole outside the game, and serves one or more games. In this manner, a single taxing system can serve several or numerous video games, sharing revenues among them as agreed upon by the game owners or as determined by the tax system.

The real or virtual cash payment can have a monthly or other periodic limit. For example, once a character has earned $30 worth of virtual tax credits in a month, the taxes are no longer charged to his character account for that month.

In addition or in the alternate, as a player's activity increases in the game environment, his tax rate can decline. For example, a player who generates up to 1000 units of virtual credit could be taxed 10%, 1001-2000 8%, 2001-5000 5%, and so on.

All or just selected characters associated with a given player account can or may be required to contribute to the tax payment amount.

In another embodiment, if taxes are not automatically collected, and/or if the player character has insufficient real or virtual funds (or credit lines) to pay taxes (and any interest or penalties, if any) when due, the player character may suffer from one or more of the following penalties including, but not limited to temporary or permanent: restrictions to play the game or part of the game, damage or other loss to an item, player character, points awarded, restricted access to, or use of or partial loss of any assets, items, game space, missions, characters, avatars, skills, communications abilities, etc., or temporary or limited play, such as slower character movement (or speed of communications) or response times, limited access to services or income, e.g., a garnishing of wages until the tax debts (plus interest if any) are collected in part or in full, artificial “lag” imposed on the player or the player character(s) of the player, or any other penalties or restrictions determined by the game owner, game server or any other authorized entity, e.g., an elected official, body, bank, agency, etc.

According to an embodiment, third parties can rent server space from the game provider and provide this structure to other players in the game. In one embodiment, the game server may charge a monthly virtual or real fee to the third party or other player, who then sells play time on the game server to other players. All or part of the fees paid can be in virtual or real dollars, that are secured with a real world credit card that is charged if the virtual fees collected in a given month are not adequate to cover the specified monthly fee.

In one embodiment, a player may be given the option of paying a periodic fee with cash, services or with virtual money taxed to his characters or via a credit card or other financial instrument. For example, the fee could be free for 10% of the virtual cash collected in a given month with a fixed minimum. In addition or in the alternate, the fee could be half price for 7% of the virtual cash in a given month with a fixed minimum. In another embodiment, the character has to pay a minimum monthly virtual cash amount, or his credit card is charged a minimum monthly fee.

In one embodiment, all the characters associated with a given player account can contribute to the monthly payment. Alternatively, it may be the voluntary or involuntary duty of less than all the characters associated with a given account to make such payments. In the event that a limited number of players do not make payment(s), the final amounts owed may fall to those not generally required to make such tax payments, which payments may also include penalties and/or interest.

In another embodiment, a character may be given a reduced monthly fee or a monthly fee credit for the amount of time he manages NPCs and/or provides other services in or to the game environment.

A third party server or third party entity, as opposed to the game server, can charge the periodic fee or any other fee disclosed herein.

Accordingly, the presently described system may comprise a plurality of various hardware and/or software components. It will be understood that a nearly unlimited number of variations are possible and that such description is intended to provide a non-limiting example of an implementation that could be utilized but should not be used to define the entire scope of the invention.

Accordingly, system 10 may be configured to perform the various functions described above may incorporate one or more servers capable of running any number and/or combination of software modules configured to perform various tasks. Exemplary combinations of servers and software modules useful for the presently-described system include:
1. A Game Server
   a. Player Activity/Event Tracking Program
   b. Fee Determination Program
   c. Virtual Title Program
   d. Currency Conversion Program
   e. Periodic Billing Program
   f. Alerts Program
2. Exchange Server
   a. Currency Conversion Program
   b. Item Exchange Program
3. Real World Billing Account Server
   a. Player Billing Program
   b. Revenue Distribution Program
4. Game Server Franchisee Server (for third parties who rent game space from game server)
   a. Franchise Monitoring Program
   b. Player Activity Tracking Program
5. Billing Provider Server
   a. Periodic Billing Program
   b. Revenue Distribution Program

System 10 may further include a number of databases configured to store and associate the various types of data that are used by the system to perform the functions described above. Exemplary databases useful for the presently-described system include:

Game Server

| 1. | Player Database | |
|---|---|---|
| | a. | Player ID |
| | b. | Player Personal Info |
| | c. | Player Real Currency Account Information |
| | d. | Player Character Name 1-n |
| | e. | Account created date/time |
| | f. | Characters Owned or Controlled ID 1-n |
| 2. | Player Financial Information Database | |
| | a. | Player ID |
| | b. | Fee Plan/Preferences |
| | c. | Player Billing Information |

| | |
|---|---|
| 1. | Credit Card(s) 1-n |
| 2. | Billing Preference |
| 3. | Account type |
| 4. | Currency Preferences |

| | |
|---|---|
| d. | Player Account Balances 1-n |

| | |
|---|---|
| 1. | Current Amount Due − Total |

| | |
|---|---|
| a. | Details 1-n |

| | |
|---|---|
| i. | Date/Time |
| ii. | Due From ID |
| iii. | Due Amount |
| iv. | Due Currency |
| v. | Terms and Conditions |

| | |
|---|---|
| 2. | Current Amounts Owed − Total |

| | |
|---|---|
| a. | Details 1-n |

| | |
|---|---|
| i. | Date/Time |
| ii. | Owed by ID |
| iii. | Owed Amount |
| iv. | Owed Currency |
| v. | Terms and Conditions |

| | |
|---|---|
| 3. | Financial Transaction History 1-n |

| | |
|---|---|
| a. | Transaction ID |
| b. | Date/Time of Transaction |
| c. | Type |
| d. | Amount |

| 3. | Player Character Database | |
|---|---|---|
| | a. | Character ID |
| | b. | Character Name |
| | c. | Title ID |
| | d. | Character Attributes 1-n |
| | e. | Character Rules 1-n |
| | f. | Virtual Cash Currency Preferences 1-n |
| | g. | Real Cash Currency Preferences 1-n |
| | h. | Virtual Cash Account 1-n |

| | |
|---|---|
| 1. | Account Number 1-n |
| 2. | Account Balance 1-n |

| | |
|---|---|
| i. | Real Cash Account 1-n |

| | |
|---|---|
| 1. | Account Number 1-n |
| 2. | Account Balance 1-n |

| | |
|---|---|
| j. | Credit Card Account 1-n |

| | |
|---|---|
| 1. | Account Number 1-n |
| 2. | Account Balance 1-n |

| | k. | Virtual Item ID 1-n |
|---|---|---|
| 4. | Currency Conversion Database | |
| | a. | Currency ID |
| | b. | Currency Description |
| | c. | Usage Rules 1-n |
| | d. | Exchange Rate/Date 1-n |
| | e. | Exchange Fees 1-n |
| 5. | Player Character Activity Database | |
| | a. | Player Character Name/ID 1-n |
| | b. | Date/Time/Duration of Activity |
| | c. | Activities 1-n |

| | |
|---|---|
| 1. | Activity Name |
| 2. | Activity Type |
| 3. | Quantity 1-n |
| 4. | Quality |
| 5. | Narrative/Additional Info 1-n |
| 6. | Outcomes 1-n |

| 6. | Tax Rule Rate Database | |
|---|---|---|
| | a. | Tax Rule ID 1-n |

| | |
|---|---|
| 1. | Applies To − Item/Activities IDs 1-n |

| | |
|---|---|
| a. | Application Rules 1-n |

| | |
|---|---|
| i. | Tax Name |
| ii. | Tax Method |
| iii. | Tax Rate |
| iv. | Default Currency |

| 7. | Franchisee Database | |
|---|---|---|
| | a. | Franchisee ID 1-n |

| | |
|---|---|
| 1. | Name |
| 2. | Player, Character or other Owner Ids 1-n |
| 3. | Ownership Percentages |
| 4. | Personal Information |
| 5. | Terms and Conditions |
| 6. | Financial Data |

| | |
|---|---|
| a. | Billing Information |
| b. | Currency Preferences |
| c. | Payment Terms |
| d. | Revenue Sharing Terms |

| 8. | Virtual Transaction Database | |
|---|---|---|
| 9. | Transaction ID | |
| | a. | Date/Time |
| | b. | Type of Transaction |
| | c. | Player ID 1-n |

| | |
|---|---|
| 1. | Character ID 1-n |
| 2. | Title ID 1-n |

| | |
|---|---|
| d. | Third Party ID 1-n |
| e. | Franchisee/or other ID 1-n |
| f. | Financial Data |

| | |
|---|---|
| 1. | Bill To ID, Date & % 1-n |
| 2. | Bill From ID, Date & % 1-n |

| | |
|---|---|
| g. | Terms Data |

| | |
|---|---|
| 1. | Creation/Use Rules |
| 2. | Payment Terms |
| 3. | Interest Terms |
| 4. | Penalty Terms |

| | |
|---|---|
| h. | Item ID 1-n |

| | |
|---|---|
| 1. | Item Title ID 1-n |

| | i. | Other Transaction Data (varies based on transaction type) |
|---|---|---|
| 10. | Virtual Item Database | |
| | a. | Item ID |
| | b. | Item Title ID |
| | c. | Item Description |
| | d. | Free Form Notes 1-n |
| | e. | Item Attributes 1-n |
| | f. | Item Rules (i.e., construction, use, disposal, restrictions, etc.) - |
| | | 1-n |
| | g. | Financial Information |

| | |
|---|---|
| 1. | Original Cost |
| 2. | Original Currency Type |
| 3. | Improvements 1-n |
| 4. | Lifespan |
| 5. | Health |
| 6. | Damage |
| 7. | Depreciation |
| 8. | Current Value |
| 9. | Current Value Currency Type |
| 10. | Liens 1-n |
| 11. | Loans 1-n |

| 11. | Virtual Title Database | |
|---|---|---|
| | a. | Item Title ID |
| | b. | Item ID |
| | c. | Original Creator/Player ID and Ownership % 1-n |
| | d. | Created Date |
| | e. | Current Owner/Player ID and Ownership % 1-n |
| | f. | Manifest Data |

| | |
|---|---|
| 1. | All Previous Owners/Player IDs (1-n) |
| 2. | Original Ownership Percentages 1-n |
| 3. | Remaining ownership interest percentages |
| 4. | Remaining Liens/Loans outstanding 1-n |

Exchange Server
1. Currency Conversion Database
   a. Currency ID
   b. Currency Description
   c. Usage Rules 1-n
   d. Exchange Rate/Date 1-n
   e. Exchange Fees 1-n
2. Fee Database
   a. Fee ID
   b. Fee Description
   c. Fee Amount/Calculation Method
   d. Fee Usage Rules 1-n

Real World Billing Account Server

| | |
|---|---|
| 1. | Player Account Database |

| | |
|---|---|
| a. | Player ID |
| b. | Player Personal Info |
| c. | Player Real Currency Account Information |
| d. | Player Financial Account Information |
| e. | Player Games Played Id 1-n |

| | |
|---|---|
| 1. | Player Character Name 1-n |

| | |
|---|---|
| a. | Account created date/time |
| b. | Characters Owned or Controlled ID 1-n |

| | |
|---|---|
| i. | Player Billing Information |

| | |
|---|---|
| 1. | Credit Card(s) 1-n |
| 2. | Billing Preference |
| 3. | Account type |
| 4. | Currency Preferences |

| | |
|---|---|
| ii. | Player Account Balances 1-n |

| | |
|---|---|
| 1. | Current Amount Due − Total |

| | |
|---|---|
| a. | Details 1-n |

| | |
|---|---|
| i. | Date/Time |
| ii. | Due From ID |
| iii. | Due Amount |
| iv. | Due Currency |
| v. | Terms and |
| | Conditions |

| | |
|---|---|
| 2. | Current Amounts Owed − Total |

| | |
|---|---|
| a. | Details 1-n |

| | |
|---|---|
| i. | Date/Time |
| ii. | Owed by ID |
| iii. | Owed Amount |
| iv. | Owed Currency |
| v. | Terms and Conditions |

| | |
|---|---|
| 3. | Financial Transaction History 1-N |

| | |
|---|---|
| a. | Transaction ID |
| b. | Date/Time of Transaction |
| c. | Type |
| d. | Amount |

Game Server Franchisee Server
1. Franchisee Database
   a. Franchisee ID Number
   b. Franchisee Name
   c. Franchisee Billing Information
   d. Games Supported 1-N
   e. Servers Supported 1-N
2. Activity Database
   a. Activity ID
      1. Time/Date
      2. Transaction Type
      3. Amount
      4. Description
      5. Game ID
      6. Server ID

Accordingly, a system such as that described herein will be configured to perform various functions, such as those described above, by performing various method steps in order to accomplish one or more given tasks. Non-limiting examples of methods that may be performed by a system and the steps that the system may execute in order to perform these methods are described below:

Determine and Apply Real World Fee Based on Player Activity and Player Billing g Preferences
1. Load Databases
2. Receive and Store Player Billing Preferences
3. Track Player Activity
4. Determine and Store Fee Due based on Activity, Fee or Tax Tables
5. Charge Fee Due to Player Real World Account (periodic limit, multi character)
6. Notify Player of fee due (email, on log in, etc)

Distribute Fees
1. Retrieve Fee/Tax Collected
2. Determine parties who are entitled to fee/tax and amount of fee they are entitled to
3. Allocate fee/tax to appropriate parties based on rules

Create Virtual Title for Virtual Items
1. Receive an indication that a virtual item has been created
2. Generate a registration number
3. Assign registration number to virtual item

Create new virtual title and Store virtual item registration number with title
1. Determine fee due for item creation and/or registration
2. Charge fee to item creator account
3. Output registration number to item creator

Update Virtual Title Database
1. Receive an indication that a virtual item has been sold
2. Determine fee(s) due from item buyer and/or seller
3. Charge fee(s) due to appropriate entities
4. Register new item owner
5. Transmit item registration number to new item owner

Other exemplary programs or modules that may be employed by a system according to the present disclosure include the following programs which may have the following capabilities:

Setup/Maintain Databases and Player Activity/Event Tracking Program (Primary Routine)
1. Load Databases and Rules Databases
2. Receive indication that tracking event has occurred
3. Execute Periodic Billing Program
4. Execute Revenue Distribution Program
5. Execute Virtual Title Program
6. Execute Alerts Program
7. Update Databases

Periodic Billing Program
1 Determine if event is taxable
2. If taxable, determine tax amount due
3. Send tax notice (if applicable)
4. Collect tax (if applicable)
5. Execute Currency Conversion Program (if required)

Revenue Distribution Program
1 Determine if collected tax/or other revenues, fees or duties should be shared/distributed and to whom or when
2. Notify Affected Parties (if applicable)
3. Execute Currency Conversion Program (only if and as required)
4. Distribute Collected Taxes/Funds as and when required

Virtual Title Program
1. Determine if title should be created, changed or deleted
2. Create, change or delete Virtual Title as required
3. Notify all affected Parties (if applicable)

Currency Conversion Program
1. Determine if currency conversion is required
2. Calculate currency conversion rates
3. Determine currency conversion fees, duties or tariffs
4. Collect fees, duties or tariffs for currency conversion (if applicable)
5. Execute Revenue Distribution Program (if and as required)

According to yet another embodiment, the present disclosure provides a game server that hosts multiple games provided by individual third parties and pays fees to the individual games based on play characteristics. According to this embodiment, a player can play in games created and managed by other individuals that are hosted by the game server. The game server can collect a periodic fee in virtual or real currency and give percentages of that fee to individuals whose game environments were used.

For example, a player plays 5 games of different individual games that are all available through a central game provider server. He pays a monthly fee of $20 to the game provider server to have access to all the individual games available on that server. He plays one game 50% of the time, and the other games 12.5% of the time. At the end of the month, the game provider server charges the player's credit card $20. The game provider server keeps $10, transfers $5 to the account of the individual game that the player played with 50% of his game time and $1.25 to each of the other games that the player played.

Suitable methods for calculating and collecting fees by, for example, charging and collecting taxes are disclosed above. Such methods could be incorporated in the presently described embodiment.

In one embodiment, fee distribution can be based on the percentage of time a player plays each game in ratio to each other, or in ratio to the total possible play time in a given month. For example, a player may only play 30% of the total available play time in a given month and 50% of that play time may be spent playing a particular game. The game server would charge the player $20 and pay the game provider $20×30%×50% or $3.

Alternatively, fees may be adjusted up or down rather than, or in addition to, the above-described percentage basis. For example, if the player plays a game that is designated as a “premium” game, the player may pay an additional fee, which may be determined as a percentage, a weighted value, a fixed dollar premium based on times played, amount of time played, number of turns, amount of real or virtual revenue or assets generated, purchased, sold, bartered, deposited, disposed of, etc.

The games provided by other individuals can be unique games or just instances of the same game that have slightly different rules associated with them.

In certain embodiments of the present invention, revenue/tax notices, and/or billing notices, revenue/tax collections, and/or revenue/tax sharing or distributions communications may be effected by using an applications program interface i.e., an API, and/or through use of an alerts or any other suitable communications method(s). Suitable methods for providing alert messages and communications are disclosed in greater detail below.

In yet another embodiment, players must pay a flat monthly fee for access to any or all games. In addition or in the alternate, players may also be required to pay taxes as described above.

In another embodiment, players may receive credits on amounts due if they successfully encourage other potential or prospective players to sign up to one or more games or servers. Such credits may be one time, fixed or variable, or may cause a permanent reduction in fees or taxes due. Said credits may be based or determined by any one or more of the following, including, but not limited to: the number and type of accounts the player signs up for, the duration of the membership, the amount of fees and/or taxes paid by the new (i.e., successfully converted) player, etc., and/or any of the forgoing as it may apply to the new player, i.e., a pyramid system, etc.

The third parties that rent the game space from the game provider can pay players a piece of the fee they receive from the game server. For example, a third party could pay a player 50% of the fee it collects from the game provider in the form of virtual currency if the player plays at least 75% of his game time, or a minimum of 10 hours in the game provider by the third party.

Accordingly, system 10 may be configured to perform the various functions described above and may incorporate one or more servers capable of running any number and/or combination of software modules configured to perform various tasks. Exemplary combinations of servers and software modules useful for the presently-described system include:

Game Servers
1. Player Activity Tracking Program
2. Billing Program
3. Allocation of Fees Collected Program
4. Alert Program

Third Party (Franchisee Server)
1. Player Activity Tracking Program
2. Share of Fees Collected Allocation Program (share fees with Players)
3. Alert Program

Real World Account Server(s)
1. Billing Program
2. Alert Program

Exchange Servers
1. Currency Conversion Program
2. Alert Program

System 10 may further include a number of databases configured to store and associate the various types of data that are used by the system to perform the functions described above. Exemplary database architectures useful for the presently-described system include:

Game Server:

| 1. | Player Database | |
|---|---|---|
| | a. | Player ID |
| | b. | Player Personal Info |
| | c. | Player Real Currency Account Information |
| | d. | Player Character Name 1-n |
| | e. | Account created date/time |
| | f. | Characters Owned or Controlled ID 1-n |
| 2. | Player Financial Information Database | |
| | a. | Player ID |
| | b. | Fee Plan/Preferences |
| | c. | Player Billing Information |

| | |
|---|---|
| 1. | Credit Card(s) 1-n |
| 2. | Billing Preference |
| 3. | Account type |
| 4. | Currency Preferences |

| | |
|---|---|
| d. | Player Account Balances 1-n |

| | |
|---|---|
| 1. | Current Amount Due − Total |

| | |
|---|---|
| i. | Details 1-n |

| | |
|---|---|
| 1. | Date/Time |
| 2. | Due From ID |
| 3. | Due Amount |
| 4. | Due Currency |
| 5. | Terms and Conditions |

| | |
|---|---|
| b. | Current Amounts Owed − Total |

| | |
|---|---|
| i. | Details 1-n |

| | |
|---|---|
| 1. | Date/Time |
| 2. | Owed by ID |
| 3. | Owed Amount |
| 4. | Owed Currency |
| 5. | Terms and Conditions |

| | |
|---|---|
| c. | Financial Transaction History 1-N |

| | |
|---|---|
| i. | Transaction ID |
| ii. | Date/Time of Transaction |
| iii. | Type |
| iv. | Amount |

| 3. | Player Character Database | |
|---|---|---|
| | a. | Character ID |
| | b. | Character Name |
| | c. | Title ID |
| | d. | Character Attributes 1-n |
| | e. | Character Rules 1-n |
| | f. | Virtual Cash Currency Preferences 1-n |
| | g. | Real Cash Currency Preferences 1-n |
| | h. | Virtual Cash Account 1-n |

| | |
|---|---|
| 1. | Account Number 1-n |
| 2. | Account Balance 1-n |

| | |
|---|---|
| i. | Real Cash Account 1-n |

| | |
|---|---|
| 1. | Account Number 1-n |
| 2. | Account Balance 1-n |

| | |
|---|---|
| j. | Credit Card Account 1-n |

| | |
|---|---|
| 1. | Account Number 1-n |
| 2. | Account Balance 1-n |

| | k. | Virtual Item ID 1-n |
|---|---|---|
| 4. | Currency Conversion Database | |
| | a. | Currency ID |
| | b. | Currency Description |
| | c. | Usage Rules 1-n |
| | d. | Exchange Rate/Date 1-n |
| | e. | Exchange Fees 1-n |
| 5. | Player Character Activity Database | |
| | a. | Player Character Name/ID 1-n |
| | b. | Date/Time/Duration of Activity |
| | c. | Activities 1-n |

| | |
|---|---|
| 1. | Activity Name |
| 2. | Activity Type |
| 3. | Quantity 1-N (e.g., time played) |
| 4. | Quality |
| 5. | Narrative/Additional Info 1-N |
| 6. | Outcomes 1-N |

| 6. | Fee/Tax Rule Rate Database | |
|---|---|---|
| | a. | Tax Rule ID 1-N |

| | |
|---|---|
| 1. | Applies To - Item/Activities IDs 1-n |

| | |
|---|---|
| a. | Application Rules 1-N |

| | |
|---|---|
| i. | Tax Name |
| ii. | Tax Method |
| iii. | Tax Rate |
| iv. | Default Currency |

| 7. | Franchisee Database | |
|---|---|---|
| | a. | Franchisee ID 1-N |

| | |
|---|---|
| 1. | Name |
| 2. | Player, Character or other Owner Ids 1-n |
| 3. | Ownership Percentages |
| 4. | Personal Information |
| 5. | Terms and Conditions |
| 6. | Financial Data |

| | |
|---|---|
| a. | Billing Information |
| b. | Currency Preferences |
| c. | Payment Terms |
| d. | Revenue Sharing Terms |

| 8. | Virtual Transaction Database | |
|---|---|---|
| | a. | Transaction ID |

| | |
|---|---|
| 1. | Date/Time |
| 2. | Type of Transaction |
| 3. | Player ID 1-n |

| | |
|---|---|
| a. | Character ID 1-n |
| b. | Title ID 1-n |

| | |
|---|---|
| 4. | Third Party ID 1-n |
| 5. | Franchisee/or other ID 1-n |
| 6. | Financial Data |

| | |
|---|---|
| a. | Bill To ID, Date & % 1-n |
| b. | Bill From ID, Date & % 1-n |

| | |
|---|---|
| 7. | Terms Data |

| | |
|---|---|
| a. | Creation/Use Rules |
| b. | Payment Terms |
| c. | Interest Terms |
| d. | Penalty Terms |

| | |
|---|---|
| 8. | Item ID 1-n |

| | |
|---|---|
| a. | Item Title ID 1-n |

| | |
|---|---|
| 9. | Other Transaction Data (varies based on transaction |
| | type) |

Exchange Server
1. Currency Conversion Database
   a. Currency ID
   b. Currency Description
   c. Usage Rules 1-n
   d. Exchange Rate/Date 1-n
   e. Exchange Fees 1-n
2. Fee Database
   a. Fee ID
   b. Fee Description
   c. Fee Amount/Calculation Method
   d. Fee Usage Rules 1-n

Real World Billing Account Server

| | |
|---|---|
| 1. | Player Account Database |

| | |
|---|---|
| a. | Player ID |
| b. | Player Personal Info |
| c. | Player Real Currency Account Information |
| d. | Player Financial Account Information |
| e. | Player Games Played Id 1-n |

| | |
|---|---|
| 1. | Player Character Name 1-n |

| | |
|---|---|
| a. | Account created date/time |
| b. | Characters Owned or Controlled ID 1-n |

| | |
|---|---|
| i. | Player Billing Information |

| | |
|---|---|
| 1. | Credit Card(s) 1-n |
| 2. | Billing Preference |
| 3. | Account type |
| 4. | Currency Preferences |

| | |
|---|---|
| ii. | Player Account Balances 1-n |

| | |
|---|---|
| 1. | Current Amount Due − Total |

| | |
|---|---|
| a. | Details 1-n |

| | |
|---|---|
| i. | Date/Time |
| ii. | Due From ID |
| iii. | Due Amount |
| iv. | Due Currency |
| v. | Terms and |
| | Conditions |

| | |
|---|---|
| 2. | Current Amounts Owed − Total |

| | |
|---|---|
| a. | Details 1-n |

| | |
|---|---|
| i. | Date/Time |
| ii. | Owed by ID |
| iii. | Owed Amount |
| iv. | Owed Currency |
| v. | Terms and Conditions |

| | |
|---|---|
| 3. | Financial Transaction History 1-N |

| | |
|---|---|
| a. | Transaction ID |
| b. | Date/Time of Transaction |
| c. | Type |
| d. | Amount |

Game Server Franchisee Server
1. Franchisee Database
   a. Franchisee ID Number
   b. Franchisee Name
   c. Franchisee Billing Information
   d. Games Supported 1-N
   e. Servers Supported 1-N
2. Activity Database
   a. Activity ID
      1. Time/Date
      2. Transaction Type
      3. Amount
      4. Description
      5. Game ID
      6. Server ID
      7. Franchisee ID
3. Player Character Activity Database
   a. Player Character Name/ID 1-n
   b. Date/Time/Duration of Activity
   c. Activities 1-n
      1. Activity ID
      2. Activity Name
      3. Activity Type
      4. Quantity 1-N
      5. Quality
      6. Narrative/Additional Info 1-N
      7. Outcomes 1-N
4. Revenue Share Rules Database
   a. Share Rule ID 1-n
      1. Rule Name
      2. Description
      3. Rules 1-n
      4. Fee/Tax Amount

Accordingly, system 10 may be configured to perform the various functions described above may incorporate one or more servers capable of running any number and/or combination of software modules configured to perform various tasks. An exemplary method that may be formed by system 10 comprises performing the following steps:
1. Track player activity
2. Determine and receive periodic fee due from player
3. Determine third party allocation of payment due
4. Pay third party based on allocation
5. Determine revenue share between third party and player based on conditions
6. Remove revenue fee from third party accounts
7. Apply revenue fee to player accounts (i.e. a rebate for pay to play offers)

Other exemplary programs or modules that may be employed by a system according to the present disclosure include the following programs which may have the following capabilities:

Setup/Maintain Databases and Player Activity/Event Tracking Program (Primary Routine)
1. Load Databases and Rules Databases
2. Receive indication that tracking event (e.g., revenue sharing event) has occurred (may use alert events)
3. Execute Periodic Billing Program
4. Execute Revenue Distribution Program
5. Execute Virtual Title Program
6. Execute Alerts Program
7. Update Databases

Periodic Billing Program
1. Determine if event requires payments
2. Send billing notice (if applicable)
3. Collect revenue (if applicable)
4. Execute Currency Conversion Program (if required)

Revenue Distribution Program
1 Determine if collected tax/or other revenues, fees or duties should be shared/distributed and the amount and to whom or when
2. Notify Affected Parties (if applicable)
3. Execute Currency Conversion Program (only if and as required)
4. Distribute Collected Taxes/Funds as and when required

Virtual Title Program
1. Determine if title should be created, changed or deleted
2. Create, change or delete Virtual Title as required
3. Notify all affected Parties (if applicable)

Currency Conversion Program
1. Determine if currency conversion is required
2. Calculate currency conversion rates
3. Determine currency conversion fees, duties or tariffs
4. Collect fees, duties or tariffs for currency conversion (if applicable)
5. Execute Revenue Distribution Program (if and as required)

According to yet another embodiment, the present disclosure provides a method and system to embed a financing module into the virtual store of a massive multi player online game.

Disclosed is a financing module that can be integrated, interfaced, or embedded in a virtual store or shopping cart of an online game or third party website that sells virtual currency and/or virtual items for one or more virtual games or virtual worlds. A game server, third party server, or character controlled virtual store sells virtual items to or player characters or third parties. During each transaction, one or more players (and/or their player character(s)) are given the ability to finance all or part of the purchase being made. Based on the virtual purchase total, a choice of one or more payment options is generated and presented to the player character(s) by the financing module.

When there are two or more payment and/or financing options presented, said options may all be generated and presented by a single financing module (or entity), or one or more of said options may be generated and presented by more than one, e.g., competing financing modules (or entities). The financing module(s) may reside within the virtual store, game server, or anywhere, e.g., on a third party financing server or any combination of the forgoing. If the player character accepts a virtual finance option, the shop is paid the full or other agreed upon amount of the purchase, plus they may also receive a fixed or variable amount or percentage of the fees and/or interest or other fees or penalties charged by the financing module(s). The finance option may be secured by a credit card that is associated with the player or another person who is associated with and is guaranteeing the player's repayment of the loan. The credit card associated with the player is registered at the time the finance option is accepted, or is the credit card on file with the game or finance module server that it uses to collect monthly or other fees from the player.

As a non-limiting example, a player character wins an auction for a virtual item on an in game auction site run by another character in Second Life. The winning bid is 200 LD, which has a US dollar value of $20. The in game auction site has agreed to have the finance option module embedded in its checkout page. The finance module calculates two finance offers to make to the buyer: 40 LD a month for 6 months and 25 LD a month for 12 months, the game server also receives another financing option from a third party financing server module for 15 LD a month for 24 months. On the check out screen all three of the finance offers are presented to the buyer, which screen may or may not also include an option to pay with cash, use a credit or debit card, or be billed later. If the buyer accepts one of the finance offers, the credit card he has on file may be pinged to make sure there is adequate balance to cover the $20 purchase price and, optionally, the expected interest charges or other fees. If there is an adequate balance, a virtual finance contract is created, the seller is paid 200 LD plus (optionally) a 10 LD finder's fee, and the buyer is given immediate or delayed access or a code to access the virtual product. At the end of the month, the player character is notified that he has a payment due. If the player character does not make the payment, his credit card is charged the real cash value of the payment plus any exchange or conversion fees plus any optional processing or additional penalty fees.

In an embodiment, the system may alert one or more players or other entities via use of an alert system. For example, the system might alert a player that an unpaid loan is or will be coming due. In another embodiment, the system might alert a player that he has one or more loan offers available. Methods for sending such alerts are disclosed in greater detail.

According to an embodiment, fees and interest payments can be split or otherwise shared with the shop owner (on an equal or other share basis) including, but not limited to:
1. When they are paid
2. When the finance option is accepted
3. After one or all the finance payments have been made
4. Any combination of theses options.

In another embodiment, the shop owner receives less than the full sale amount, which amount may be paid to the finance option owner as a fee for providing such financing. In this example, either the shop owner and/or the buyer may pay a financing fee. Such fee(s) may be equal or disproportionate to each other and may or may not be based upon other factors such as the total purchase price, the prevailing or current interest charges, the buyer or seller's credit ranking or other risk determining factors, by agreement or otherwise.

In one embodiment, before the finance option can be accepted, the credit card associated with the player can be pinged to “freeze” i.e., place a hold on a portion or all of the available credit line equal to the total purchase price or a finance payment amount and/or expected or projected total fees and/or penalties and other fees, e.g., currency conversion fees and/or some other determined amount that may be less than or equal to or greater than the purchase price, and/or the purchase price plus part or all of the anticipated finance fees or charges, etc. The credit card company may provide this as a new or added service to further secure the credit line and debts. In one embodiment, the credit card company receives a portion of the finance or other fees in exchange for placing a hold on a player's credit card account for part or the entire amount due. In another embodiment, the credit card company or credit card processing agent prevents the credit card holder from cancelling and/or changing his credit card or terms and/or from charging any charges going forward and/or processing any new charges that would or may cause the credit card holder's balance to exceed an amount that would preclude charging part or all of the unpaid finance amount to the card in the event of a current or future default. Such limits may include potential finance charges and/or other fees in whole or in part.

Alternatively, as long as the credit card on file with the game server is valid (i.e. the last monthly fee cleared without an issue) the finance option will be considered secured with that card on file. Only players who have a credit card on file can receive finance offers in this embodiment.

In another embodiment, if a player fails to pay a real or virtual loan or finance charges when due, one or more other real or virtual players, and/or game owner, and/or server owners, lending institutions and/or any third party may have or may be granted or presented with the option to pay for part or all of the default or outstanding debt amounts (in real, virtual or credit card currency and/or via a new loan, which new loan may be secured by such party). The defaulting player would then be obligated to repay the new lender by any acceptable means, including but not limited to, any one or more of the following: a) according to the original loan terms and conditions, plus a possible fine, penalty, additional or new interest rate, b) through indentured service, c) bartering, d) surrender of one or more of any collateral whether or not such collateral was encumbered or attached to the original loan, and/or e) through the performance of any other act, service, or execution of new or additional documents/contracts, and/or other activities approved by the new lender(s), e.g., loan the lender armor or troops, or teach a method, or declare war on another player, etc.

In another embodiment, if a player fails to pay a real or virtual loan, said player's credit card or credit line is only charged for the delinquent amount, plus any penalties, and not the entire amount. In the event of such “monthly default” subsequent months may be charged to the player's credit card at or generally near the due date.

In yet another embodiment, as the player pays down the balance, the credit card hold amount is reduced by an equal or some other amount. The balance may be reduced equal to the amount paid down or it may only be reduced by a percentage of the amount paid. For example, if the balance due including expected financing charges is $100 USD, and the player pays down $10 USD, the credit card hold amount might be reduced by only $7 USD. This difference may be affected by the total amount due, the duration of the loan, the credit worthiness of the player, the total amount outstanding for all or a group of players, payment history, the expected total amount due, the item purchased (e.g., based upon its rate of depreciation or expected useful life or the relative liquidity or after market for said item, e.g., collateral), the skill level or age of the player or other attributes of the player, the total net worth or asset base of the player, the availability of the player's credit line or other financial instruments, the level of participation by the credit card company, or any other attributes, financial variables, or information regarding the player, the provider of credit, the credit card company or any combination of the foregoing.

In another embodiment, players or player characters may designate a “Preferred virtual credit card.” In this case, the preferred virtual credit card” and/or its real world counterpart's credit line must be used up before an alternate or secondary card can be used or pinged. In addition or in the alternate, one or more outstanding balance(s) must be paid (in whole or in part) before other real or virtual balances can or are paid.

In another embodiment, the real or virtual lender of real or virtual loan may charge or offer a lower interest rate, and/or pay or provide other favorable loan terms and conditions to obtain, retain, or otherwise have the privilege or option of being designated or considered as the preferred, default or primary card.

In another embodiment, as a player accepts financing options on multiple purchases, a hold on his credit line may increase the sum of all purchases (and/or total of all outstanding amounts) or the hold may not increase with each purchase. For example, if a given player proves credit worthy and pays his bills on time, the amount of the credit hold may be a percentage of the total amount outstanding, or a percentage of the amount outstanding plus part or all of the expected financing costs, e.g., interest and/or penalties. In this fashion, those with low credit risk may not tie up all of their available credit line.

Groups of the finance agreements (of one or more player characters, etc.) can be bundled and sold (in part or in whole) to other entities by the finance option module provider. The value of the bundles can be based on the default rate of the agreements. Those agreements having a high default rate have a greater value than those having a low default rate because the agreements include the right to charge the credit card associated with the player character. A genetic algorithm can be used to determine the most appropriate loans to package and sell in groups. In another embodiment, the value of the agreement(s) may be higher or lower than their face or full value and such value may be determined by any one or more of: an agreement among the parties, as a percentage of the total current amount outstanding, the value or based on the value of the matured obligation, the credit worthiness of one or more of the borrowers and/or their payment history, the expected interest, penalties or other fees and charges in addition to or instead of the overall value of the loan obligation(s), or a combination of these or any other financing valuation, which combination may or may not make use of weighted scoring algorithms.

The real cash value of any contract secured with a credit card could automatically be determined and charged to the credit card on file when the player attempts to cancel his account with the finance option module provider and/or the credit card could be charged if the card holder attempts to make one or more additional charges (within the game or otherwise) that may or would reduce an amount needed to be held as a guarantee. For example, if a player accepts a virtual loan and secures said loan with his credit card, and such security requires $500 of an available remaining balance of $700, in the even that such player attempts to charge $201 or more, the system could automatically submit a charge for the full loan amount of $500 so that said credit line is used to pay the outstanding loan obligation and is not used for other purchases (whether or not such purchases are made within the game or in the real world or in another related or unaffiliated game.

The interest rate that is determined for the finance option module can be affected by a number of factors. For example, higher rates to those with little or no credit. Lower rates to those that have large available credit lines that are willing to provide a percentage of their line to secure other player's who don't have real world credit cards.

The finance option offers can be calculated based in part on the age of the buyer's account with the game. In one embodiment, a player with an older account can receive finance offers with a greater number of payments, or at a lower interest rate or a combination of these, or other more favorable terms and conditions, e.g., a payment grace period for late payments.

In another embodiment, a character may be given a reduced interest rate, monthly fee or a monthly fee credit for the amount of time he manages NPCs and/or provides other services in the game environment.

In another embodiment, the lender may be one or a group of players or player characters that may have agreed to provide such loans on a regular or onetime or other basis. For example, three players that have available real or virtual currency and/or real or virtual available credit lines, may agree to form a lending institution (on a permanent or temporary basis). For example, such players may provide information about the amount of currency they are willing to loan in total and/or for each given loan, and/or the amount of risk they are willing to take, or the specific or general types of loans they are willing to participate in, e.g., a player may be willing to loan a total of $1,000 LD, but only in increments of $10 LD to any given player and then only for the purchase of assets that have a strong resale market and that are not subjected to losses, such as during battle. Likewise, other players submit such information as to the total amounts available, the terms of availability including: time start and end of availability, total amount per loan, loan proceeds use restrictions or permissions, acceptable minimum or range of interest rates, risk level (e.g., real or virtual credit score, skill level, type of account, total net worth, past payment history or any other financial indicator of borrower), security level (e.g., no security required, assets purchased as collateral, credit card as guarantee, or credit cards from participating providers only, additional collateral, e.g., in addition to or instead of the purchased asset as collateral, a lender may require additional collateral which may be based on a percentage of the total loan or other predetermined amount, or one or more risk factors, etc.).

The system then may aggregate such available funds, combining such funds based upon the factors listed above. Combination may be based upon least common denominators, e.g., by maximum loan amount, or risk levels, etc., and/or present such availabilities to players at the time of purchase or at any other times as determined by the lenders, game owner, servers, etc. Presentations may include the list of individual or aggregated loans that are available for use and their terms and conditions, including interest rates, collateral or additional collateral requirements, length of loan, penalties, security deposits or security interests, etc. In another embodiment, loan options are made in real currency, within the game and/or to anyone via the Internet for use of proceeds within the real world.

In yet another embodiment, when aggregating virtual or real cash and/or real or virtual credit lines that may be used collectively to make loans, players or other entities providing such loans may provide information that indicates which variables or factors are more important, i.e., which should carry more weight in evaluating whether or not such a player's financial means are used to provide a certain loan, and/or to determine the level or amount of participation. For example, three players with excess virtual cash decide, (perhaps with or without initial consultation), to offer $10 LD, $20 LD and $30 LD, respectively. Player one, with an offer of $10 LD, might indicate that he is only willing to participate at a $1 LD per loan level, i.e., for a total of 10 $1 LD loans. Furthermore, player one may specify that he will only participate when and if the total loan request is $1 OLD or more, in otherwords, player one does not wish his investment to account for more than 10% of any given loan. Meanwhile, player two, with an offer of $20 LD, decides she is not sensitive to risk and would prefer higher rates of return, so player two indicates in her loan profile that she is willing to lend any or all of the $20 LD to any one or more players for one or more loans, i.e., there is no minimum or maximum loan limitations. However, player two does indicate that she will only loan the funds when the interest rate exceeds 20%. Finally, player three might adopt a mixed strategy, i.e., earmarking some of the $30 LD to high risk loans, while restricting some portion of his funds only to small loan amounts and then only to high credit rating players.

In the embodiment described above, the system would determine which funds to use from which players (and/or third party lenders) and aggregate such funds as needed depending upon the demand, rules, restrictions, market, player contracts, etc. In this way, a large pool of available real and virtual cash could be tapped and/or a large pool or real and/or virtual credit lines could be used, individually and/or collectively or in any combination to help assure available loans for any players requesting such loans.

In another embodiment, any part or all of any required real or virtual currency and/or real or virtual loan requirements that cannot or may not be satisfied by such internal financial means or as otherwise desired, might be provided by one or more third parties. For example, in the event that all available resources internally or as otherwise provided to a game to be made available for loans were already issued to players or that is otherwise unavailable for one or more given virtual loan opportunities, such system might send a notification to one or more third parties. Such third parties may be registered or known to the system as potential sources of funds, or such third parties may only be generally identified as possible lenders, e.g., existing credit card companies, banks, trusts, etc. Such notification may be via electronic means or automated interfaces. For participating institutions, such communication may be in the form of a loan request notice, which notice may include the total amount required, the credit information of the individual(s) requesting such loan and other terms, such as interest and/or penalties information. The recipient of such notice may respond electronically or via other means to indicate that such institution is willing and able to meet all or part of the loan, and may agree to the requested loan terms and conditions and/or may offer other terms, e.g., a higher interest rate, or a quicker payoff term.

Upon receipt of a response, the system can present the loan(s) offer(s) along with revised terms and conditions (if any). The player character players may then accept or reject the loan and/or, optionally, spread the obligation among multiple loan offers. For example, the first offer may be at a very low interest rate and carry other favorable terms, but might only cover 50% of the loan. While all other loan offers might cover the full balance of the obligation, but under less favorable terms. In such instances, the player, if made available to him, may elect to pay for 50% of the balance using the first loan offer, while paying the remaining 50% using one or more other loans with less favorable terms. Each lender and/or player may have the option to spread loan risk using this method. In some instances, players may not be offered such terms. Once the loan amount and lenders have been determined, and such loans are presented to players, players may then accept (or reject) such loan(s) any time (in whole or in part), or only within a limited timeframe, including when purchasing an item, or anytime such funds may be desired, e.g., just prior to the commencement of a battle or for building a tangible or intangible asset, paying service or other fees when due, or paying off an existing debt or loan, etc.

When any payments come due for any of the options listed above, a currency conversion fee may apply. For example, if a player fails to pay a virtual amount when due, the system may charge his credit card for the amount due in real currency, but also may charge a fee for converting the virtual amount into a real amount. Such fee may be based upon a predetermined amount agreed to by the parties or it may fluctuate based upon current conversion rates within the game or by existing marketplaces, or may be a percentage, or based upon a present or future calculated value of any of these variables and/or a combination of any of the forgoing.

In one embodiment of the present invention, a method is provided that enables pulling money back out of the game, for example, for those that loan the money. For example, once a lender receives payment from one or more borrowers, such lender may decide to re-loan part or all of such proceeds or withdraw part or all of such proceeds. If not already converted into real currency, a currency conversion fee may apply prior to withdrawal. In another embodiment, such withdrawal is made in the “in game currency” or virtual currency. Such currency may be converted to a real currency at some future date.

Lenders may or may not be permitted to alter the terms under which they are willing to grant a loan. For example, a lender that indicated previously that she was willing to loan the funds for “any purpose” so long as the interest rate exceeds 20%, may decide that she would prefer that only half be used for such purpose while the other half may now be earmarked for less risky ventures.

In another embodiment, two or more games may decide to create links or “cross-cooperation” agreements among two or more virtual games. For example, if a player defaults within Eve, a message or alert is sent to his account in Second Life and his assets may be frozen, virtual currency exchanged or sold, game play fees increased and/or shared, etc. This option might have the added benefit of creating a larger economy, i.e., much like the EU or NAFTA.

Such game to game exchanges or interchanges might also include the sharing of available loan amounts, terms, conditions, credit information and the like.

In an embodiment, the system may send messages or alerts to one or more players or other entities via use of an alert system. For example, the system might alert a player that an unpaid bill is or will be coming due. In another embodiment, the system might alert potential lender that there is or will be a need for additional loan funds and invite that lender to loan additional funds and/or modify the terms of use for such proceeds. Methods for sending such alerts are disclosed by applicant's patent application are described in greater detail below.

Another embodiment addresses the issue of game defaults, i.e., the occurrence of a video game ceasing to exist or otherwise going out of business. As there may be numerous outstanding loans, those that loaned funds would be concerned as to their recovery of such loan amounts. In one embodiment, it is anticipated that lenders will have agreements directly with the credit card institution that holds the card used for a loan. In the event of a default, bankruptcy, technical or other failure of a given video game, all loans might become immediately due and payable (in whole or in part), and upon failure to pay, the credit card(s) might be charged. In another embodiment, upon any such default by a game, the credit cards would be automatically charged, without first giving the player the option to pay using other means. Such terms may be included in general game play contracts, and/or may be included in the terms and conditions of individual loans. Certain loans without such protective measures (for the lender) may carry a higher interest rate, due to the higher risk. In another embodiment, players might first receive an alert that notifies them of their options prior to charging their credit card(s).

In yet another embodiment, such loans may be transferred to participating games or successor games and/or to third party financing entities that agree (in advance or at the time of default) to assume such loans. When transferring or assuming such loans, they may be transferred or assumed under the same terms as when originated, or they may carry new or modified terms and conditions. For example, when transferring an outstanding loan, the entity assuming such loan may impose a higher interest rate and/or require the borrower to agree to additional terms or provide additional security or collateral. In another embodiment, borrowers may be presented new loan repayment options, and/or may be offered additional virtual or real cash to be added to the transferred loan.

In the event of a return, the merchant can notify the third party loan provider. The third party loan provider would then notify the virtual merchant of the remainder of the virtual loan that is due. The merchant would repay the loan balance by assuming the loan. The third party loan provider could waive any interest payments for such returns.

Accordingly, system 10 may be configured to perform the various functions described above and may incorporate one or more servers capable of running any number and/or combination of software modules configured to perform various tasks. Exemplary combinations of servers and software architecture useful for the presently-described system include:

Game Server
1. Finance Participation Program
2. Finance Offer Qualification Program
3. Offer Generation Program
4. Revenue Distribution Program
5. Loan Payment Program
6. Loan Bundling Program
7. Loan Exchange Program
8. Alerts Program
9. Virtual Title Program

Exchange Server
1. Currency Conversion Program

Real World Billing Account Server
1. Player Billing Program
2. Revenue Distribution Program

Billing Provider Server
1. Periodic Billing Program
2. Revenue Distribution Program

Virtual Store Server
1. Transaction Program
2. Loan Offer Program

Financing Module Provider Server
1. Finance Offer Program
2. Loan Payment Program
3. Loan Profit Share Program

Real World Billing Server
1 Billing Program

System 10 may further include a number of databases configured to store and associate the various types of data that are used by the system to perform the functions described above. Exemplary database architectures useful for the presently-described system include:

Game Server

| 1. | Player Database | |
|---|---|---|
| | a. | Player ID |
| | b. | Player Personal Info |
| | c. | Player Real Currency Account Information |
| | d. | Player Character Name 1-n |
| | e. | Account created date/time |
| | f. | Characters Owned or Controlled ID 1-n |
| 2. | Player Financial Information Database | |
| | a. | Player ID |
| | b. | Fee Plan/Preferences |
| | c. | Player Billing Information |

| | |
|---|---|
| 1. | Credit Card(s) 1-n |
| 2. | Billing Preference |
| 3. | Account type |
| 4. | Currency Preferences |

| | |
|---|---|
| d. | Player Account Balances 1-n |

| | |
|---|---|
| 1. | Current Amount Due − Total |

| | |
|---|---|
| a. | Details 1-n |

| | |
|---|---|
| i. | Date/Time |

| | |
|---|---|
| b. | Due From ID |

| | |
|---|---|
| i. | Due Amount |
| ii. | Due Currency |
| iii. | Terms and Conditions |

| | |
|---|---|
| c. | Current Amounts Owed − Total |

| | |
|---|---|
| i. | Details 1-n |

| | |
|---|---|
| 1. | Date/Time |

| | |
|---|---|
| ii. | Owed by ID |

| | |
|---|---|
| 1. | Owed Amount |
| 2. | Owed Currency |
| 3. | Terms and Conditions |

| | |
|---|---|
| d. | Financial Transaction History 1-N |

| | |
|---|---|
| i. | Transaction ID |
| ii. | Date/Time of Transaction |
| iii. | Type |
| iv. | Amount |

| 3. | Player Character Database | |
|---|---|---|
| | a. | Character ID |
| | b. | Character Name |

| | |
|---|---|
| 1. | Title ID |
| 2. | Character Attributes 1-n |
| 3. | Character Rules 1-n |
| 4. | Virtual Cash Currency Preferences 1-n |
| 5. | Real Cash Currency Preferences 1-n |
| 6. | Virtual Cash Account 1-n |

| | |
|---|---|
| a. | Account Number 1-n |
| b. | Account Balance 1-n |

| | |
|---|---|
| 7. | Real Cash Account 1-n |

| | |
|---|---|
| a. | Account Number 1-n |
| b. | Account Balance 1-n |

| | |
|---|---|
| 8. | Credit Card Account 1-n |

| | |
|---|---|
| a. | Account Number 1-n |
| b. | Account Balance 1-n |
| c. | Virtual Item ID 1-n |

| 4. | Currency Conversion Database | |
|---|---|---|
| | a. | Currency ID |
| | b. | Currency Description |
| | c. | Usage Rules 1-n |
| | d. | Exchange Rate/Date 1-n |
| | e. | Exchange Fees 1-n |
| 5. | Finance Offer Database | |
| | a. | Offer Rule ID |
| | b. | Offer Rule Name |
| | c. | Offer Rule |
| | d. | Offer Terms and Conditions |
| 6. | Player Character Activity Database | |
| | a. | Player Character Name/ID 1-n |
| | b. | Date/Time/Duration of Activity |
| | c. | Activities 1-n |

| | |
|---|---|
| 1. | Activity Name |
| 2. | Activity Type |
| 3. | Quantity 1-N |
| 4. | Quality |
| 5. | Narrative/Additional Info 1-N |
| 6. | Outcomes 1-N |

| 7. | Virtual Title Database | |
|---|---|---|
| | a. | Item Title ID |
| | b. | Item ID |
| | c. | Original Creator/Player ID and Ownership % 1-n |
| | d. | Created Date |
| | e. | Current Owner/Player ID and Ownership % 1-n |
| | f. | Manifest Data |

| | |
|---|---|
| 1. | All Previous Owners/Player IDs (1-N) |
| 2. | Original Ownership Percentages 1-n |
| 3. | Remaining ownership interest percentages |
| 4. | Remaining Liens/Loans outstanding 1-n |

| 8. | Player Activity Database | |
|---|---|---|
| | a. | Player Character Name/ID 1-n |
| | b. | Date/Time/Duration of Activity |
| | c. | Activities 1-n |

| | |
|---|---|
| 1. | Activity Name |
| 2. | Activity Type |
| 3. | Quantity 1-N |
| 4. | Quality |
| 5. | Narrative/Additional Info 1-N |
| 6. | Outcomes 1-N |

| 9. | Loan Provider Database | |
|---|---|---|
| | a. | Provider ID |
| | b. | Billing Information |
| | c. | Credit ID |
| | d. | Total Amount Available (real, virtual) |
| | e. | Total Loan Amounts outstanding |
| | f. | Loan Uses/Restriction Rules 1-N and amounts |
| 10. | Loans Database | |
| | a. | Loan ID # |

| | |
|---|---|
| 1. | Lender ID # 1-N |
| 2. | Loan Details 1-N |
| 3. | Loan Amount |
| 4. | Maturity Date |
| 5. | Borrower (e.g., Player) ID 1-N |
| 6. | Interest Rate |
| 7. | Security Method 1-N and preferences |
| 8. | Use of proceeds limitation rules (if any) 1-N |
| 9. | Collateral 1-N |

| 11. | Virtual Store (Merchant) Database | |
|---|---|---|
| | a. | Store ID # |
| | b. | Owner ID # (e.g., Player or vendor ID) |
| | c. | Finance options 1-N |
| 12. | Inventory Database | |
| | a. | Item # ID |
| | b. | Item Description |
| | c. | Long Description (free form text) |
| | d. | Item Use Rules 1-N |
| 13. | Player Character Database | |
| | a. | Player Character ID |
| | b. | Player Character Owner Player ID |
| | c. | Player Character Description |
| | d. | Player Character Attributes 1-N |
| | e. | Loan ID 1-N |

| | |
|---|---|
| 1. | Original Amount |
| 2. | Principal Balance |
| 3. | Interest Rate |
| 4. | Maturity Dates |

Financing Module Provider Server
1. Player Database
   a. Player ID
   b. Loan ID(s)
   c. Player Personal Info
   d. Player Billing Info
   e. Profit Share ID
2. Merchant Database
   a. Merchant ID
   b. Merchant Terms and Conditions
   c. Profit Share ID
3. Loan Database
   a. Player ID
   b. Loan Terms and Conditions
   c. Loan Start Date
   d. Loan Payment Schedule
   e. Payments Made
   f. Payments Remaining
   g. Loan Title ID and information
4. Loan Condition Database
   a. Loan Condition ID
   b. Loan Condition Descriptor
5. Loan Profit Share Database
   a. Profit Share ID
   b. Profit Share Condition
   c. Profit Share Amount
6. Loan Bundle Database
   a. Loan Bundle ID
   b. Loan IDs 1-N
7. Loan Bundle Conditions Database
   a. Condition ID
   b. Condition Descriptor
8. Game Server Database
   a. Game Server ID
   b. Player ID
   c. Game Server Billing Info
   d. Game Server Alert Info

Exchange Server
1. Transaction Database
2. Currency Conversion Database
   a. Currency ID
   b. Currency Value

Fee Database
1. Fee Type
   a. Currency Pair Exchange
   b. Volume/Amount Exchange

Real World Billing Account Server
1. Player Account Database
   a. Account ID
   b. Player Personal Info
   c. Player Billing Info
   d. Account Terms and Conditions
   e. Account Real Cash Credit Limit
   f. Account Virtual Cash Credit Limit

Game Server Franchisee Server
1. Franchisee Database
   a. Franchisee ID
   b. Franchisee Billing Info
2. Activity Database
   a. Activity Date and Time
   b. Activity Description

Billing Server
1. Player Database
   a. Player ID
   b. Player Personal Info
   c. Player Billing Info

Accordingly, a system such as that described herein will be configured to perform various functions, such as those described above, by performing various method steps in order to accomplish one or more given tasks. Non-limiting examples of programs or modules that may be employed by a system according to the present disclosure include the following programs which may have the following architectures and/or capabilities:

Game Server
1. Qualify Character for Loans
   a. Retrieve Player Record
   b. Retrieve Loan Conditions
   c. Determine appropriate Loan eligibility of Player based on player record and loan conditions
2. Determine Appropriate Finance Offers
   a. Receive Transaction Request
   b. Retrieve Player Record
   c. Retrieve available finance offers including conditions for making offer
   d. Determine appropriate finance offers based on player record and available finance offers
   e. Store Offers
3. Make Finance Offers
   a. Retrieve Transaction Request from a merchant
   b. Retrieve available finance offers
   c. Output Finance Offers
   d. Receive acceptance of one or more loan offers
   e. Store loan offer acceptance including player id, merchant id, and transaction information
   f. Create Loan Record including Loan title
4. Track Loan Payments
   a. Receive a request to play a loan
   b. Retrieve loan record
   c. Apply payment to loan and update record
5. Distribute Loan Profits
   a. Retrieve loan records
   b. Determine eligible profit share entities
   c. Generate profit share amounts
   d. Distribute profit share amounts to appropriate entities
   e. Generate Loan Bundles
   f. Retrieve Loan Records
   g. Retrieve Loan Bundle Conditions
   h. Generate Loan Bundles based on Loan Records and Bundle Conditions
   i. Store Loan Bundle Records
6. Post Bundles on Exchange
   a. Retrieve Loan Bundles
   b. Post Loan Bundle on Exchange
   c. Receive requests to purchase Loan Bundles
   d. Flag Loan Bundle as sold based on purchase requests and Loan Bundle Sale Rules
7. Transfer Title of Loans when Loans are Exchanged
   a. Receive indication that loan has been sold
   b. Retrieve Loan Title
   c. Update Loan Title with new Loan owner

Virtual Store Server
1. Generate Loan Offer
   a. Receive a transaction request from a player
   b. Output a loan offer request to Loan Module Provider Server
   c. Receive Appropriate Loan Offers
   d. Output Loan Offers to player
   e. Receive acceptance of Loan Offer
   f. Output Loan acceptance offer to Loan Module Provider Server
   g. Flag transaction as paid
2. Receive Payment
   a. Output acceptance of loan offer to Loan Module Provider Server
   b. Receive payment for transaction plus any fees associated with securing a loan

Financing Module Provider Server
1. Make Finance Offer
   a. Receive a request for a loan from merchant server including, merchant id, player id, player profile, and merchant profile
   b. Retrieve and/or Generate Loan Offers based on request
   c. Output loan offer to merchant
2. Set Up Loan
   a. Receive a notice of acceptance for a loan offer
   b. Transmit payment for full loan amount, plus applicable fees to merchant
   c. Create new loan record including player info, amount info, payment info, merchant info, and title info
3. Process Loan Payments
   a. Retrieve Loan Record
   b. Determine if payment is due
   c. Output request for payment and/or initiate automatic payment
   d. Receive payment
   e. Store payment amount and date with loan record
4. Generate Loan Bundles
   a. Retrieve a loan record
   b. Determine if loan record is appropriate for inclusion in a loan bundle
   c. If loan record is appropriate for inclusion in a loan bundle, add loan id to loan bundle id
5. Post Bundles on Exchange
   a. Retrieve Loan Bundle Record
   b. Register Loan Bundle on Exchange
6. Transfer Title of Loans when Loans are Exchanged
   a. Receive indication that a loan bundle has sold
   b. Register sale of loans in bundle with exchange
   c. Transfer Loan Title to new Loan Owner

Other exemplary programs or modules that may be employed by a system according to the present disclosure include the following programs which may have the following capabilities:

Setup/Maintain Databases.
1. Load and Update Databases as Necessary

Player Activity/Event Tracking Program (Primary Routine)
1. Load Databases and Rules Databases
2. Receive indication that purchase may or has occurred
3. If yes, Execute Loan Offer Generation Program
4. If not, Determine if Loan Payment is due
5. If yes, Execute Loan Periodic Billing Program
6. Execute Revenue Distribution Program
7. Execute Virtual Title Program
8. Execute Alerts Program
9. Update Databases

Loan Offer Generation Program
1. Determine Purchase Total Amount
2. Determine funds availability and terms
3. Determine loan offers based upon data and rules
4. Determine if player satisfies loan requirements, including sufficient credit line, collateral, payment history, etc. to meet lender(s)' requirements
5. If meets requirements, Present offer(s) to player(s)
6. Else, deny loan request or send notice to third party lenders (if applicable) and present loan offers
7. Receive indication that one or more loans were accepted
8. Update databases

Loan Periodic Billing Program
1. Determine if loan payment is due
2. If due, determine amount due
3. Send notice (if applicable)
4. Collect amount due (if applicable)
5. If amount not collected, determine total due including penalties and fees (if any) and charge credit card
6. Execute Currency Conversion Program (if required)

Revenue Distribution Program
1. Determine if loan proceeds belong to one or more lenders
2. If due, determine amount due
3. Send notice
4. Send amount as required

According to another embodiment, the present disclosure provides a virtual loan offer based on the status and/or attributes of a player or player character

A system that analyzes a player or player character account and/or transaction history and/or current activities to determine a desire, need or potential need and/or receive a request for one or more loans and provides one or more loan offers from one or more virtual and/or real credit card providers and/or from one or more of their existing credit cards, and/or one or more real or virtual banks and/or other real or virtual financial institution, and/or one or more player characters or one or more third parties that have agreed to provide funds for such loans.

A character, server or game, or other application logs real and/or virtual transaction history. If the transaction volume of the player declines or increases by a certain virtual dollar or percentage amount, or if the player character's current or expected cash requirements fall below what the character can or is expected to be able to generate, or if a player accesses or requests information or views products, services, attributes or plans for activities, e.g., plans a battle, or is otherwise interested in products, services, property or other items that might exceed his capacity to pay for part or all of such products, services, property or other items, (e.g., the player views a piece of land that costs 2,000 LD, but that player only has 200 LD) and/or if it is otherwise determined that the player character needs or will need, or desires or could benefit from an infusion or loan of cash (immediately or in the perceivable future, real or virtual) the system determines an appropriate loan offer amount, based on the spending history or virtual credit score of the player, or based upon a calculated or determined need, and retrieves loan offers from the game server or third parties. The loan offers are presented to the player.

In an embodiment, the system applies only to the real world, including real currency and real people. In another embodiment, the system applies only to the virtual world, including virtual characters and virtual currency. In yet another embodiment, the system may operate within both the real and the virtual worlds, for example, offering a real loan that can be converted into virtual currency for use within the real or a virtual world.

In one embodiment of the present invention, the system is characterized by its flexibility to consider one or more variables in determining when to make a loan offer and the amount of the loan. For example, such determination might be based on any applicable data, variable or action, including any one or more of or any combination of a/an:
1. A request by one or more players and/or player characters to receive one or more loan offers.
2. A suggestion by one or more players and/or player character to present one or more loan offers to one or more other players and/or player characters.
3. Current or projected virtual or real cash balance(s) of one or more virtual players and/or player characters
4. Rate (or change in rate, or predicted change or expected rate) of virtual or real funds demands or use of such funds
5. Existing real or virtual loans or real or virtual notes coming or that may become due (i.e., secure another loan to pay off a maturing loan)
6. Predicted need for real or virtual funds (e.g., the game determines what are typical requirements for users throughout game play such as a given player in question, based upon average use of funds by other similarly situated players, i.e., the system determines over time that players at various points of game play require a loan, e.g., new players tend to have less virtual cash, but greater demand for such cash, or, players about to engage in battle or a protracted war need extra cash to fund continued game play while supporting or participating in such a conflict), etc. Other non-limiting examples include: a construction loan is coming due; a product that has been requested or purchased is shipping soon, but the player account lacks the necessary funds; a known or predicted need for funds for an impending tax liability; war or conflict; and other known or predicable loss, e.g., due to illness, computer or player attacks, skill level of the player and the point or position of play as compared with others that have been similarly situated and have similar playing styles or have made similar playing choices or decisions, or otherwise etc.)
7. Filing of a virtual lien or a demand of payment on another virtual note by a lender, or another player or any lending institution or credit card company, etc.
8. Game play fees are or may become due.
9. Projected or actual failure to fulfill any virtual contract or any terms thereof that has or may have financial consequences e.g., penalties attached, e.g., failure to make a payment or provide a good or service when due under the terms of an agreement or as required by the game or another player or third party entity.
10. Expectation, prediction to or recently lost in-game battle for which the player owes or may owe a virtual bounty or other virtual reparations or costs or fees. And/or the cost to rebuild assets or armies, or other items or attributes as a result of such anticipated or actual losses.
11. The amount of time a player has been playing a game or a number of turns
12. The skill level of the player character in the game
13. The age or other attributes of a player character or the owner of the player character
14. Projected or actual price increases within the game for items, attributes, activities, or other costs
15. A projected or actual need for funds, e.g., the player is considering or actually making a purchase and said player's funds are either insufficient to make such a purchase or if sufficient, after said purchase would leave such player with either no funds, or limited funds, or funds less than as desired, projected, or required to successfully continue game play or via any other applicable calculation or determination method.
16. Projected or actual changes in currency conversion rates within the game or outside the game.
17. A loan request by the player or an agent of the player
18. A loan request by a real or virtual store manager or owner
19. A loan request by a broker or other player or NPC that has received indications from a prospective borrower that the player may be interested in a loan.
20. Loans requested and/or consummated by other players, e.g., an enemy or adversary of the prospective borrower player
21. The number of times the player checks prices on an auction or in a virtual store for virtual items that his account does not have enough virtual cash to cover.
22. A history of a player showing acceptance of previous loan offers
23. An indication by a player that he may accept a loan, such as a player “opting in” to a loan offer program or otherwise indicating a general interest to receive marketing offers or loan offers.
24. The likelihood that a loan will be accepted given the known conditions and/or the loan amount and/or its terms and conditions, including, but not limited to the interest rate or term.
25. Any one or more alert conditions or alert events or in response to one or more alerts.
26. The change, occurrence or desire to achieve or thwart any one or more game objectives or goals.
27. Any combination of any or all of the forgoing methods.

Loan offers can be made to the player or player character:
1. On the log in screen of the game
2. Via voicemail, email, text message or automated outbound call
3. In a pop up window of or directly on the game GUI
4. On a website that is external to the game
5. On a check out page of a virtual store or virtual auction
6. Via an alert or other message
7. Via oral, text and/or graphical communications by a loan agent, NPC or any other third party, including player characters
8. Storage of the offer on a database, with an icon or other notice method
9. Any applicable means of communications
10. And/or any one or more of the foregoing

Additional examples, and methods for determining and presenting loans are disclosed herein.

In an alternative embodiment, the system presents loan options randomly, or periodically, e.g., when a player signs on or off, without use of other knowledge of the player. In such instances, such loans may or may not be granted to the prospective borrower until such player's creditworthiness is determined. Subsequent offers may or may not be affected by a player accepting or rejecting such loan or other loan offers.

Such loans may be simply an offer to apply for a loan with an amount or no amount or two or more amounts or a range of amounts, after which, if the player applies for the loan, the actual amounts and/or terms will be determined and/or negotiated and presented for consideration or acceptance or modification by the player.

In another embodiment, if a player fails to pay a real or virtual loan or finance charges when due, one or more other real or virtual players, and/or game owner, and/or server owners, lending institutions and/or any third party may have or may be granted or presented with the option to pay for part or all of the default or outstanding debt amounts (in real, virtual or credit card currency and/or via a new loan, which new loan may be secured by such party). The defaulting player would then be obligated to repay the new lender by any acceptable means, including but not limited to, any one or more of the following: a) according to the original loan terms and conditions, plus a possible fine, penalty, additional or new interest rate, b) through indentured service, c) bartering, d) surrender of one or more of any collateral whether or not such collateral was encumbered or attached to the original loan, and/or e) through the performance of any other act, service, or execution of new or additional documents/contracts, and/or other activities approved by the new lender(s), e.g., loan the lender armor or troops, or teach a method, or declare war on another player, etc.

In another embodiment, if a player fails to pay a real or virtual loan, said player's credit card or credit line is only charged for the delinquent amount, plus any penalties, and not the entire amount. In the event of such “monthly default” subsequent months may be charged to the player's credit card at or generally near the due date.

In another embodiment, third party players, NPC's, business entities within the game or outside the game, including real entities and/or third parties, may choose to approach any player at random or by using any of the aforementioned methods to determine need or desire, including any or all of player characteristics and discuss loans and make offers for loans. Such offers may be specific or general. In each case, the terms may be determined before making such a loan offer, or such terms may be determined only after the player expresses interest in a loan and/or provides a loan amount request or provides a loan application, etc., at which time, the specifics of the loan may be determined and presented to the player.

In one embodiment, loan offers and/or notices to lenders requesting funds for loans, and/or other communications required between the game server and players and/or between lenders and borrowers, and/or between any two or more of game servers, billing systems, lending institutions, players, player characters, banks, credit card companies, etc., may be handled via direct communications and/or by using alerts. For example, the system might alert a player that a loan is available to pay for a recent or current purchase and/or a loan is or will be coming due. In another embodiment, the system might alert a player that he has failed to make a payment on a loan and now has a penalty payment due as well. Or, the system might notify one or more possible lenders that there is a need for loan funds for one or more desired or needed or requested loans. Methods for sending such communications and/or alerts are discussed later in this disclosure.

When a loan is in default, it can be placed on an exchange where creditors can bid on buying the defaulted loan at the full default or some other predetermined or negotiated or discounted rate.

In another embodiment, a character may be given a reduced interest rate or other favorable loan terms and/or receive a lower monthly fee or a monthly fee credit for the amount of time he manages NPCs and/or provides other services in the game environment and/or if he accepts and/or pays one or more loans.

In yet another embodiment, the real or virtual lender of real or virtual loan may charge or offer a lower interest rate, and/or pay or provide other favorable loan terms and conditions to obtain, retain, or otherwise have the privilege or option of being designated or considered as the preferred, default or primary card.

Accordingly, system 10 may be configured to perform the various functions described above and may incorporate one or more servers capable of running any number and/or combination of software modules configured to perform various tasks. Exemplary combinations of servers and software modules useful for the presently-described system include:

Game Server
a. Player Activity/Event Tracking Program
b. Loan Offer Determination/Generation Program
c. Alerts Program

Virtual Loan Provider Server
a. Loan Offer Determination/Generation Program
b. Loan Payment Program
c. Alerts Program

Real or Virtual World Financial Server
a. Loan Payment Program

System 10 may further include a number of databases configured to store and associate the various types of data that are used by the system to perform the functions described above. Exemplary database architectures useful for the presently-described system include:

Game Server
1. Player Database
   a. Player ID
   b. Player Personal Info
   c. Player Real Currency Account Information
   d. Player Character Name 1-n
   e. Account created date/time
   f. Characters Owned or Controlled ID 1-n
2. Player Financial Information Database
   a. Player ID
   b. Fee Plan/Preferences
   c. Player Billing Information
      1. Credit Card(s) 1-n
      2. Billing Preference
      3. Account type
      4. Currency Preferences
   d. Player Account Balances 1-n
      1. Current Amount Due—Total
         a. Details 1-n
         i. Date/Time
         ii. Due From ID
         iii. Due Amount
         iv. Due Currency
         v. Terms and Conditions
      2. Current Amounts Owed—Total
         a. Details 1-n
         i. Date/Time
         ii. Owed by ID
         iii. Owed Amount
         iv. Owed Currency
         v. Terms and Conditions
      3. Financial Transaction History 1-N
         a. Transaction ID
         b. Date/Time of Transaction
         c. Type
         d. Amount
3. Player Character Database
   a. Character ID
   b. Character Name
   c. Title ID
   d. Character Attributes 1-n
   e. Character Rules 1-n
   f. Virtual Cash Currency Preferences 1-n
   g. Real Cash Currency Preferences 1-n
   h. Virtual Cash Account 1-n
      1. Account Number 1-n
      2. Account Balance 1-n
   i. Real Cash Account 1-n
      1. Account Number 1-n
      2. Account Balance 1-n
   j. Credit Card Account 1-n
      1. Account Number 1-n
      2. Account Balance 1-n
   k. Virtual Item ID 1-n
   l. Loan ID 1-N
4. Currency Conversion Database
   a. Currency ID
   b. Currency Description
   c. Usage Rules 1-n
   d. Exchange Rate/Date 1-n
   e. Exchange Fees 1-n
5. Finance Offer Database
   a. Offer Rule ID
   b. Offer Rule Name
   c. Offer Rule
   d. Offer Terms and Conditions
6. Player Character Activity Database
   a. Player Character Name/ID 1-n
   b. Date/Time/Duration of Activity
   c. Activities 1-n
      1. Activity Name
      2. Activity Type
      3. Quantity 1-N
      4. Quality
      5. Narrative/Additional Info 1-N
      6. Outcomes 1-N
7. Virtual Title Database
   a. Item Title ID
   b. Item ID
   c. Original Creator/Player ID and Ownership % 1-n
   d. Created Date
   e. Current Owner/Player ID and Ownership % 1-n
   f. Manifest Data
      1. All Previous Owners/Player IDs (1-N)
      2. Original Ownership Percentages 1-n
      3. Remaining ownership interest percentages
      4. Remaining Liens/Loans outstanding 1-n
8. Player Activity Database
   a. Player Character Name/ID 1-n
   b. Date/Time/Duration of Activity
   c. Activities 1-n
      1. Activity Name
      2. Activity Type
      3. Quantity 1-N
      4. Quality
      5. Narrative/Additional Info 1-N
      6. Outcomes 1-N
9. Loan Provider Database
   a. Provider ID
   b. Billing Information
   c. Credit ID
   d. Total Amount Available (real, virtual)
   e. Total Loan Amounts outstanding
   f. Loan Uses/Restriction Rules 1-N and amounts
10. Loans Database
   a. Loan ID #
      1. Lender ID #1-N
      2. Loan Details 1-N
      3. Loan Amount
      4. Maturity Date
      5. Borrower (e.g., Player) ID 1-N
      6. Interest Rate
      7. Security Method 1-N and preferences
      8. Use of proceeds limitation rules (if any) 1-N
      9. Collateral 1-N
11. Virtual Store Database
   a. Store ID #
   b. Owner ID # (e.g., Player or vendor ID)
   c. Finance options 1-N
12. Inventory Database
   a. Item #ID
   b. Item Description
   c. Long Description (free form text)
   d. Item Use Rules 1-N

Loan Provider Server(s)
1. Player Database
   a. Player ID
   b. Player Personal Info
   c. Player Real Currency Account Information
   d. Player Character Name 1-n
   e. Account created date/time
   f. Characters Owned or Controlled ID 1-n
2. Player Financial Information Database
   a. Player ID
   b. Fee Plan/Preferences
   c. Player Billing Information
      1. Credit Card(s) 1-n
      2. Billing Preference
      3. Account type
      4. Currency Preferences
   d. Player Account Balances 1-n
      1. Current Amount Due—Total
         a. Details 1-n
         i. Date/Time
         ii. Due From ID
         iii. Due Amount
         iv. Due Currency
         v. Terms and Conditions
      2. Current Amounts Owed—Total
         a. Details 1-n
         i. Date/Time
         ii. Owed by ID
         iii. Owed Amount
         iv. Owed Currency
         v. Terms and Conditions
      3. Financial Transaction History 1-N
         a. Transaction ID
         b. Date/Time of Transaction
         c. Type
         d. Amount
3. Player Character Database
   a. Character ID
   b. Character Name
   c. Title ID
   d. Character Attributes 1-n
   e. Character Rules 1-n
   f. Virtual Cash Currency Preferences 1-n
   g. Real Cash Currency Preferences 1-n
   h. Virtual Cash Account 1-n
      1. Account Number 1-n
      2. Account Balance 1-n
   i. Real Cash Account 1-n
      1. Account Number 1-n
      2. Account Balance 1-n
   j. Credit Card Account 1-n
      1. Account Number 1-n
      2. Account Balance 1-n
   k. Virtual Item ID 1-n
4. Currency Conversion Database
   a. Currency ID
   b. Currency Description
   c. Usage Rules 1-n
   d. Exchange Rate/Date 1-n
   e. Exchange Fees 1-n
5. Finance Offer Database
   a. Offer Rule ID
   b. Offer Rule Name
   c. Offer Rule
   d. Offer Terms and Conditions
6. Loans Database
   a. Loan ID #
      1. Lender ID #1-N
      2. Loan Details 1-N
      3. Loan Amount
      4. Maturity Date
      5. Borrower (e.g., Player) ID 1-N
      6. Interest Rate
      7. Security Method 1-N and preferences
      8. Use of proceeds limitation rules (if any) 1-N
      9. Collateral 1-N
7. Payment Database
   a. Loan ID #
   b. Payment ID #1-N
      1. Player ID
      2. Player Character ID 1-N
         a. Payment Method
         b. Total Amount Paid
         c. Amount Principal
         d. Amount Interest
         e. Amount Other

Accordingly, a system such as that described herein will be configured to perform various functions, such as those described above, by performing various method steps in order to accomplish one or more given tasks. Non-limiting examples of programs or modules that may be employed by a system according to the present disclosure include the following programs which may have the following architectures and/or capabilities:

Game Server
1. Track Player Activity
2. Compare Activity to Loan Conditions
3. Offer Loans if Activity Matches Loan Conditions
4. Alert Lender/Potential Borrower

Loan Provider Server
1. Compare Activity to Loan Conditions
2. Associate Player Character Account with Appropriate Loan Offers
3. Make Loan Offers
4. Receive Loan Payments on accepted loan offers

Other exemplary programs or modules that may be employed by a system according to the present disclosure include the following programs which may have the following capabilities:

Setup/Maintain Databases
1. Player Activity/Event Tracking Program (Primary Routine)
2. Load Databases and Rules Databases
3. Receive indication of loan need
4. Determine if loan is appropriate
5. If yes, Execute Loan Offer Generation Program
6. Determine if Loan Payment is due
7. If yes, Execute Loan Periodic Billing Program
8. Execute Revenue Distribution Program
9. Execute Virtual Title Program
10. Execute Alert Program
11. Update Databases

Loan Offer Generation Program
1. Determine Purchase Total Amount
2. Determine funds availability and terms
3. Determine loan offers based upon data and rules
4. Determine if player satisfies loan requirements, including sufficient credit line, collateral, payment history, etc. to meet lender(s)' requirements
5. If meets requirements, Present offer(s) to player(s)
6. Else, deny loan request or send notice to third party lenders (if applicable) and present loan offers
7. Receive indication that one or more loans were accepted
8. Update databases

Periodic Billing Program
1. Determine if loan payment is due
2. If due, determine amount due
3. Send notice (if applicable)
4. Collect amount due (if applicable)
5. If amount not collected, determine total due including penalties and fees (if any) and charge credit card
6. Execute Currency Conversion Program (if required)

Revenue Distribution Program
1 Determine if loan proceeds and/or payments should be shared/distributed and to whom or when
2. Notify Affected Parties (if applicable)
3. Execute Currency Conversion Program (only if and as required)
4. Distribute Collected Proceeds and/or payments as and when required

Virtual Title Program
1. Determine if virtual title should be created, changed or deleted
2. Create, change or delete Virtual Title as required (e.g., add or remove lien)
3. Notify all affected Parties (if applicable)

Currency Conversion Program
1. Determine if currency conversion is required
2. Calculate currency conversion rates
3. Determine currency conversion fees, duties or tariffs
4. Collect fees, duties or tariffs for currency conversion (if applicable)
5. Execute Revenue Distribution Program (if and as required)

Loan Participation Program
1 Determine need for loans
2. Notify potential or existing lenders
3. Receive indication that lenders will participate and receive terms and conditions for such participation
4. Update Lender Database and/or Rules Databases

According to another embodiment, the present disclosure provides an improved system to provide a real world credit card that provides benefits in massive multi player online games. The present disclosure provides a credit card that provides benefits in a MMPOG when the card holder makes purchases with the account number associated with the card. The credit card or applicable server or application may determine appropriate benefits for a player. When the player logs in to the game server, he can apply the credits/benefits earned from the credit card server to various characters associated with the player account.

Benefits may be rewarded for any one or more of the following activities, including but not limited to:
1. Opening the credit card account
2. Making purchases (real or virtual) with the card
3. Carrying a balance in real or virtual currency on the card
4. Making a certain number of purchases with the card
5. Making purchases of a certain value with the card
6. Making purchases of a certain type with the card
7. Purchasing certain items, number of items, or attributes with the card
8. Renewal of the card
9. Using the card to guarantee or otherwise secure or pay off a loan
10. Using the card to secure or pay off a loan of another player
11. Winning a battle or achieving an objective in battle
12. Finishing or starting an activity
13. Providing services in exchange for points, e.g., managing one or more NPCs and/or providing assistance to new players
14. Playing a game
15. Signing up a friend or third party to play a game
16. Signing up a friend or third party to receive their own card
17. One or more “alert events”
18. Based upon achieving or relating to one or more game objectives or goals
19. Or any combination of the above or any other activity to be rewarded as determined by the credit card issuer or by any third party willing to pay for all or part of any such reward(s)

Benefits may include any one or more of the following, including but not limited to:
1. A reduced monthly or other periodic fee to play a MMPOG (e.g., a player can play the game for free if he maintains a monthly balance of $1500 or more on the credit card)
2. Virtual cash or other credits in the game (e.g., a player can receive an amount of virtual cash each month that is equal to a certain percentage of money that he has spent with the credit card in that month)
3. Free or lower cost virtual items in the game (e.g., a player can select a certain free virtual item or attribute for his player character in the game when he has made a certain number of purchases with his real world credit card)
4. Special character selections in the game (e.g., a player can select certain special races and classes in the game if they carry a balance on their credit card associated with the game)
5. Special character attributes in the game (e.g., a player character can only have certain spells, or may receive extra “lives” or body armor, if they have a credit card or a card with a certain minimum balance)
6. Free play time, e.g., a player can receive free play time in the game environment perpetually or for a period of time if they register for a credit card and are approved and/or purchase goods with the card and/or maintain a certain minimum balance or pay on time, etc.
7. Points that may be redeemed for any of the forgoing and/or other goods, services, financial benefits, tax reductions or rebates, currency (real or virtual), etc.
8. Real items or currency, e.g., based upon a player's usage of or actual or average balance carried on the card, or as a reward for any of the activities listed above, the player may receive any of the above items, including tangible or intangible goods and services, or real items, services or currency, e.g., free real world airline tickets, or free or discounted goods, e.g., a new cell phone, etc.
9. Free or reduced cost access to game play assistance, e.g., an expert player might assist a player character to solve a puzzle
10. Use such points within the credit card's real world conversion or frequency programs.

In another embodiment, the rewards that the player has earned are presented on the login screen of the game, and the player can allocate the reward to one or more of the various player characters in his account or “gift” them to another account in part or in whole. Once the player has allocated the reward, it is made available to that character in the player account.

The player can sell the rewards to another player in the game and/or back to the rewards program at full price or at a discount as determined by the reward program and/or as agreed to by the player and the reward program.

In another embodiment, players or player characters may designate a “Preferred virtual credit card.” In this case, the preferred virtual credit card” and/or its real world counterpart's will receive points on a preferential basis over other cards. In addition or in the alternate, one or more card's points must be used before access or use of other points is granted.

The rewards can have varying values based on which character sub-account the player applies them.

A player can specify what real world dollar amount or percentage of his real world credit line can be used or allocated for virtual purchases.

Multiple virtual credit cards with different benefits can be offered to or used by the players at the same time, which offers may be based on historical play habits.

A virtual credit card can be flagged as a “preferred card”. A preferred card status would mean that the credit line is used up on this card before other virtual credit card credit lines can be used. Alternatively, the balance of this preferred card must be paid before other virtual balances of other virtual credit cards can be paid. The virtual lender can charge a lower interest rate to have the privilege of being the preferred card

Points from multiple cards may be pooled to exchange for larger or more valuable items, attributes, etc.

Benefits include:
1. Waiving the monthly fee to pay the game
2. a reduced virtual interest rate on virtual loans
3. free insurance on virtual world items

Obligations may accrue when
1. A certain number of real world transactions are made
2. A certain dollar value of real world transactions are made

Accordingly, system 10 may be configured to perform the various functions described above may incorporate one or more servers capable of running any number and/or combination of software modules configured to perform various tasks. Exemplary combinations of servers and software modules useful for the presently-described system include:

Game Server
1. Player Activity/Tracking Program
2. Rewards Notification Program
3. Rewards Allocation Program
4. Rewards Redemption Program
5. Alerts Program
6. Preferred Card Program
7. Credit Line Allocation Program
8. Credit Line Usage and Notification Program

Credit Card Server
1. Rewards Registration Program
2. Rewards Determination Program
3. Rewards Allocation Program
4. Rewards Redemption Program
5. Alerts Program
6. Credit Line Allocation Program (to set max amount of line that can be used for virtual purchases)
7. Credit Line Usage and Notification Program

System 10 may further include a number of databases configured to store and associate the various types of data that are used by the system to perform the functions described above. Exemplary database architectures useful for the presently-described system include:

Game Server
1. Player Database
   a. Player ID
   b. Player Personal Info
   c. Player Real Currency Account Information
   d. Player Character Name 1-n
   e. Account created date/time
   f. Characters Owned or Controlled ID 1-n
2. Player Financial Information Database
   a. Player ID
   b. Reward Points Total
   c. Fee Plan/Preferences
   d. Player Billing Information
      1. Credit Card(s) 1-n
      2. Billing Preference
      3. Account type
      4. Currency Preferences
   e. Player Account Balances 1-n
      1. Current Amount Due—Total
         a. Details 1-n
         i. Date/Time
         ii. Due From ID
         iii. Due Amount
         iv. Due Currency
         v. Terms and Conditions
      2. Current Amounts Owed—Total
         a. Details 1-n
         i. Date/Time
         ii. Owed by ID
         iii. Owed Amount
         iv. Owed Currency
         v. Terms and Conditions
      3. Financial Transaction History 1-N
         a. Transaction ID
         b. Description
         c. Date/Time of Transaction
         d. Type
         e. Amount
      4. Rewards Transaction History 1-N
         a. Transaction ID
         b. Description
         c. Date/Time of Transaction
         d. Type
         e. Amount
3. Player Character Database
   a. Character ID
   b. Character Name
   c. Title ID
   d. Character Attributes 1-n
   e. Character Rules 1-n
   f. Virtual Cash Currency Preferences 1-n
   g. Real Cash Currency Preferences 1-n
   h. Virtual Cash Account 1-n
      1. Account Number 1-n
      2. Account Balance 1-n
   i. Real Cash Account 1-n
      1. Account Number 1-n
      2. Account Balance 1-n
   j. Credit Card Account 1-n
      1. Account Number 1-n
      2. Account Balance 1-n
      3. Reward Points Balance 1-n
      4. Redemption Activity 1-n
      5. Virtual Item ID 1-n
4. Currency Conversion Database
   a. Currency ID
   b. Currency Description
   c. Usage Rules 1-n
   d. Exchange Rate/Date 1-n
   e. Exchange Fees 1-n
5. Virtual Reward Transaction Database
6. Transaction ID
7. Description
8. Type
9. Transaction Time/Date
10. Player ID
11. Character ID 1-N
12. Credit Card ID 1-N
13. Points Awarded/Deducted

Credit Card Server
1. Card Holder Database
   a. Card Holder ID (e.g., Player ID)
   b. Card Type (i.e. preferred)
   c. Terms and Conditions/Rules 1-n
   d. Interest Rate Rules 1-n
   e. Penalty Rules 1-n
   f. Outstanding Balance
   g. Current Minimum Amount Due
   h. Reward Points Total
   i. Virtual Transaction Database IDs 1-n
2. Transaction Database
   a. Transaction ID
   b. Description
   c. Transaction Time/Date
   d. Player ID
   e. Character ID 1-N
   f. Credit Card ID 1-N
   g. Financial Transaction Information
      1. Amount
      2. ID
      3. Additional Terms and Conditions 1-n
   h. Reward Database Activity ID 1-n
3. Rewards Database
   a. Reward Transaction ID
   b. Type
   c. Date/Time
   d. Description
   e. Unit
   f. Amount
   g. Additional Terms and Conditions 1-n
4. Rewards Conditions Database
   a. Reward Rule ID
   b. Description
   c. Type
   d. Vendor/Supplier ID
      1. Activity Type/ID
      2. Reward Amount
   e. Rules 1-n
   f. Rule Constraints 1-n

Accordingly, a system such as that described herein will be configured to perform various functions, such as those described above, by performing various method steps in order to accomplish one or more given tasks. Non-limiting examples of programs or modules that may be employed by a system according to the present disclosure include the following programs which may have the following architectures and/or capabilities:

Game Server
1. Create a reward card for a player
   a. Receive a player log on
   b. Determine if player is eligible for a credit card
   c. Output credit card offer
   d. Receive acceptance of offer including reward preferences
   e. Transmit accepted offer to credit card server
2. Receive Rewards from Credit Card Server
   a. Receive a reward including a reward id and a player id from credit card server
   b. Determine value of award
   c. Store award with player account
   d. Transmit request for payment of award value to credit card server
   e. Receive payment for award value from credit card server
3. Reward Distribution to Player Character
   a. Receive a player log in
   b. Determine if reward is available
   c. Output Reward
   d. Receive indication of player character to distribute reward
   e. Distribute reward to player character
4. Preferred Card Usage
   a. Receive a request to pay for a virtual transaction
   b. Determine if player character has a preferred credit line
   c. Determine if preferred credit line has open credit
   d. If preferred credit line has open credit, apply transaction to preferred card.
   e. If preferred credit line does not have open credit, output notice to player that preferred credit line has no available credit
   f. Process transaction with other credit line on file
5. Preferred Card Payment
   a. Receive a payment from a player for one or more credit lines
   b. Determine if there is a preferred credit line
   c. Apply payment to preferred credit line
   d. Apply payment remainder (if available) to other credit lines based on terms and conditions

Credit Card Server
1. Reward Registration
   a. Receive an indication that a new account has been created including a virtual reward preference
   b. Create new card account including reward preferences
2. Reward Determination
   a. Retrieve transaction activity
   b. Determine Reward based on activity and player preference
   c. Store Reward
3. Reward Issuance
   a. Retrieve Reward
   b. Transmit Reward record, including player id and reward id to game server
   c. Receive fee for purchasing reward from game server
   d. Pay fee to game server
4. Credit Line Allocation Program
   a. Receive a request to allocate a portion of a credit line to virtual purchases
   b. Output credit line
   c. Receive preferences for usage for real and virtual purchases
   d. Store preferences
5. Credit Line Usage Program
   a. Receive a request to purchase a virtual item with a credit card
   b. Determine credit line associated with card
   c. Determine portion of credit line allocated to virtual purchases
   d. Determine if transaction pushes virtual allocation over the credit limit
   e. If transaction does not push virtual allocation over the credit limit, process transaction using credit card as payment.

According to another embodiment, the present disclosure provides a method to allow for outcome betting on events staged in a massive multi player online game. According to this embodiment, a group of players may form a team in an MMPOG. Teams are paired against other teams to compete in a match. A match can be made available to other player characters before it starts for outcome betting. Bets can be placed by player characters in the form of virtual cash, or virtual credit secured by a real world credit card. Odds are created based on bets being made. A percentage of the pot is given to the players of the team if they win the match.

Alternatively, a group of players form a team that attempts to complete a mission in a MMPOG. Other player's can bet on:
1. Whether the team will complete the mission
2. Whether the team will complete the mission in a given period of time.
3. How many players will survive the mission.
4. Or, any other attributes or factors that are tracked by the system, e.g. points, accuracy percentages, bonus points, puzzles solved, etc.

In addition or in the alternate, two or more players and/or NPC's may compete or bet on the completion or failure to achieve one or more game objectives or goals.

According to one embodiment, wagers can be placed on player vs. player matches or team vs. team or player or team vs. computer matches. In another embodiment, only individuals can bet against each other.

According to one embodiment, the loser of the match loses experience, virtual cash or game items or other attributes are lost or adversely affected (either temporary or permanent affects).

According to one embodiment, bets are made with virtual money but may be secured with real world credit cards.

According to one embodiment, virtual teams or players may need to pay an entry fee that may be refunded if the team wins the match

According to one embodiment, an AI or expert system can track the play of players in a team to search for anomalies that indicate one or more of the team players have thrown the match. Players with anomalies can be fined, not allowed to play anymore, identified as “possible cheaters” or otherwise penalized. In another embodiment, the system tracks money transfers between players after the game to look for collusion.

In another embodiment, bettors can use reward points or other benefits accrued as a currency for betting. Such rewards or points may be used instead of or in addition to the use of real or virtual currency in placing such bets.

In another embodiment, betters can select multiple camera angles to view the battle. Alternatively, players own cameras and can dictate the camera angles used or available. Moreover, players may request instant replays using different angles.

In another embodiment, players and their teams, or their families can be allowed or disallowed from betting or limited only to betting for themselves and not the competing team.

In another embodiment, players can win special items from bettors or winning-bettors can create a pool of game attributes that the winning team receives if they win the match. Special items may be added to the purse with conditions i.e., only give this item if they win in 10 seconds or less.

In another embodiment, winning teams can randomly win items in the inventory of the losing team. At the end of the match those items are removed from the losing team's players and given to the winning team's players.

Wagers can be made based upon any virtual or in game activities, e.g., who will complete a construction project or a level in the game or who will acquire a certain item or list of items or attributes the quickest, or with the fewest casualties or with the least amount of virtual funds, etc.

In another embodiment, the system may alert one or more players or other entities via use of an alert system, such as the one described herein. For example, the system might alert a player that a wager has been won or lost or that a challenge or bet has been placed or waged. In another embodiment, the system might alert a player that he has been invited to join a team or to accept one or more partial or whole bets/wagers.

Accordingly, system 10 may be configured to perform the various functions described above may incorporate one or more servers capable of running any number and/or combination of software modules configured to perform various tasks. Exemplary combinations of servers and software modules useful for the presently-described system include:

Game Server
1. Team Formation Program
2. Bettor Registration Program
3. Odds Determination Program
4. Event Creation Program
5. Winning Distribution Program
6. Trophy Pool Creation Program
7. Reallocation of Attributes based on Event Outcome Program

System 10 may further include a number of databases configured to store and associate the various types of data that are used by the system to perform the functions described above. Exemplary database architectures useful for the presently-described system include:

Game Server
1. Player Database
   a. Player ID
   b. Player Character ID 1-N
   c. Player Billing Info
   d. Player Personal Info
2. Player Character Database
   a. Character ID
   b. Character Attributes 1-n
   c. Character Affiliations 1-n
3. Affiliation Database
   a. Affiliation ID
   b. Affiliation Type
   c. Player ID 1-n
   d. Bettor ID 1-n
   e. Player Character ID 1-n
4. Team Database
   a. Character ID 1-n
   b. Team ID
   c. Team Type
   d. Team Descriptor
5. Event Database
   a. Event ID
   b. Event Descriptor
   c. Event Date
   d. Trophy Items 1-N
   e. Teams 1-N
   f. Odds
   g. Winner ID
   h. Trophy Distribution
   i. Bets/Rewards 1-n
   j. Status
6. Bettor Database
   a. Player ID
   b. Player Character ID
   c. Bettor Conditions
   d. Bettor Limit
   e. Bettor Affiliations 1-N
7. Bettor Rules and Conditions Database
   a. Condition ID
   b. Condition Descriptor
8. Allocation of Attributes Rules and Condition Database
   a. Allocation ID
   b. Allocation Descriptor
9. Allocation of Winnings Rules and Condition Database
   a. Allocation ID
   b. Allocation Descriptor
   c. Allocation Percentage
   d. Allocation Fee
10. Team Criteria Database
   a. Team Criteria ID
   b. Team Criteria Descriptor
11. Fraud Criteria Database
   a. Fraud ID
   b. Fraud Descriptor
   c. Fraud Measurement Mechanism
12. Allocation of Penalties Rules and Conditions Database
   a. Penalty ID
   b. Penalty Descriptor
   c. Penalty Amount
   d. Penalty Rules and Conditions

Accordingly, a system such as that described herein will be configured to perform various functions, such as those described above, by performing various method steps in order to accomplish one or more given tasks. Non-limiting examples of programs or modules that may be employed by a system according to the present disclosure include the following programs which may have the following architectures and/or capabilities:

Team Registration
1. Receive a request to create a team
2. Determine if members meet team criteria
3. Create team

Event Creation
1. Generate an event based on rules and/or conditions
2. Create Event Record

Bettor Registration
1. Receive a request from a player to become a bettor
2. Determine if player qualifies as bettor
3. If player qualifies, generate a bettor profile including a bettor limit, bettor restrictions, etc.
4. Create Bettor Record including profile

Place Bet on Event
1. Receive a request to place a bet on an event from a bettor
2. Receive bet amount from bettor
3. Determine if bet amount falls within limit criteria for bettor
4. Store Bet with Event

Add Rewards/Trophy Pool to Event
1. Receive a request to add a trophy to an event
2. Determine if trophy/award is allowable
3. Add trophy to trophy pool of event

Generate Event Outcome
1. Facilitate Event
2. Generate/Determine Event Account
3. Store Event Account

Allocate winnings and trophies to betters and teams
1. Retrieve bets and trophy pool of a completed event
2. Generate allocation amounts based on allocation rules
3. Output allocations to appropriate parties based on rules

Determine Odds of an event
1. Retrieve Event Bets
2. Generate odds for event based on bets
3. Store odds

Track Fraud by Payouts from Bettors to Team Players before and after match
1. Receive an indication that a bettor has made a transaction
2. Determine if transaction was with a member of team
3. Determine if team member was part of a team that lost an event where the bettor placed a bet
4. Flag transaction as potentially fraudulent

Exclude players with close virtual relations to team members to become bettors on an event
1. Receive a request to place a bet for an event from a bettor
2. Retrieve bettor relations with team members of event
3. Determine if relations are not appropriate to allow bet
4. If relations are not appropriate, disallow bet from being placed
5. Notify bettor that bet cannot be placed to bettor relationship with one or more team members

Determine Losers of Event and Generate Penalties
1. Receive or Generate an Event Outcome
2. Determine losing team of event based on outcome
3. Determine penalties based on penalty rules
4. Apply penalties to team members

Place Virtual Bet Secured by Credit Card
1. Receive a virtual bet from a bettor
2. Generate a real world value for the virtual bet amount
3. Retrieve bettor credit card
4. Determine if credit card has adequate value to cover bet
5. Receive indication of agreement that credit card will cover value of bet
6. Store bet, secured by credit line of bettor credit card

Charge Credit Card if bet is lost
1. Receive indication that bettor has lost his virtual bet
2. Ping bettor virtual account for bet payment
3. If virtual account does not have adequate funds
4. Retrieve bettor credit card
5. Charge real cash value of virtual bet to credit card, plus applicable fees

Track virtual money transfers to find collusion between players
1. Receive an indication that virtual money has been transferred between players
2. Determine if one player was a bettor that placed a bet on an event where the other player was a member of a team
3. Flag transaction as potentially fraudulent

AI search for play anomalies to find cheaters
1. Receive potential cheating patterns
2. Analyze potential cheating patterns
3. Modify cheating patterns

Select Camera Angle(s) as bettor
1. Receive camera angle options
2. Select camera angles 1-n

Store camera angles 1-n
1. Output feed from camera angles to bettor monitor during event

According to another embodiment, the present disclosure provides a system to alert players of events and activities in a massive multi online player game using a notification device and method. In this embodiment, a player (or other entity, e.g. a games, service, application, process, NPC, lending institution, etc.) of a MMPOG or other application applies for, registers or otherwise requests a notification method and or device, i.e., an Alert, that may be internal or external to the game environment when he creates a player or player character account or other account or application or service. Once the notification method, i.e., the alert, is created and/or registered and/or requested, the player (or other entity) can create alert requests and/or automatically receive alerts when certain conditions, i.e., an alert event, has occurred, is occurring or may occur in the game environment. When an alert event or condition is met or an alert event occurs or may occur in a game environment and/or any application and/or one or more databases, API's, etc., one or more players, NPC's, applications, services, processes, games (or other designated recipient(s)) is/are notified via one or more notification methods, such as via an alert.

When an alert event may occur, occurs, or has occurred, an alert may be sent to one or more players or other entities, which alert may include information about the alert event, the player, player characters, source of the alert, application or game environment that was the source of the alert and/or other generally available information relating to or associated with the alert and/or associated or relating to any one or more game objectives or goals, or any related or otherwise affected application, system, player, player character or game environment. For example, information that may be included in an alert includes, but is not limited to:
1. Dates, including transaction dates, date of the alert event, loan maturity dates, projected completion or availability dates, etc.
2. Times or durations of the alert event
3. Types—i.e., the type of alert and/or its severity or urgency
4. Origin or sending system or application, e.g., video game name
5. Recipient or receiving system or application, e.g., player's name
6. Data (e.g., a snapshot or change log of data) before, during or after the alert event
7. Content, including images, photographs, video, text, icons, avatars, audio, hyperlinks, drawings, figures, artwork, etc.
8. Attachments, including one or more files, compressed files, hyperlinks,
   etc.
9. Variance in data, e.g., difference between bid and ask prices of virtual stocks
10. Marketing offers, e.g., an offer for one or more virtual or real loans, or a special or promotion
11. Names of one or more affected players and/or player characters and/or NPCs and/or servers and/or applications and/or franchisees and/or banks or other lending institutions or businesses
12. Financial information, including prices, discounts, volume breaks, order limits or minimum quantities, taxes, interest rates, penalties, currency conversion factors, current or expected or calculated balances and/or credit line or other limits of one or more players and/or player characters and/or servers and/or applications.
13. Activity by a Player Character including, game parameter completion, leveling, item acquisition, skill training completion, skill training initiation, etc.
14. Any other information associated with or affected by the alert event conditions, the alert and/or any one or more of a player or players and/or their player characters and/or any servers and/or applications, and/or any game objective or goal.
15. Any combination of the above.

In certain embodiments, one or more alerts may be set up, created, activated, used, delivered and/or received by/to/from entities other than and/or in addition to players. For example, alerts may be used as a means to create and/or implement one or more application's program interface(s) (i.e., an API) that provides communications between, to or among one or more various applications, players, player characters, franchisee owners, servers, server applications (e.g., periodic billing programs or revenue sharing programs), etc.

A player character may need to have a special skill in the game in order for all alerts or some alerts to work. For instance, a player may not be notified of activity of other player characters unless he has obtained a level seven in the skill “spying”

In another embodiment, one or more alerts may be set up, created, activated, used, delivered and/or received by/to/from any entity or third party (real and/or virtual) that is configured or is otherwise able to request, register, receive, submit, store, delay, forward and/or transmit such alerts.

In another embodiment, alert rules may include conditions under which an alert may not be generated and/or its transmission and/or delivery is prevented or delayed based upon rules established by the entity, device, system or application that created the alert and/or the entity, device, system or application that sends, delivers, and/or receives or is otherwise affected by said alert(s). In one embodiment, such conditions may be established by a table or rules based conditions set and/or filters. Said rules may be mutually exclusive and/or additive, nested, and/or include logical operands such as “and” “not” “or” and/or “nor” etc. Such filters may permit arguments that determine delivery characteristics of one or more alerts based upon any one or more delivery or alert factors including, but not limited to one or more of: a) time of alert creation, transmission and/or delivery, b) creator of alert, c) one or more elements of data contained and/or generally attached or associated with the alert, d) the suggested or required action(s) of such alert, e) the effect or the possible effect of the alert, f) the originator, sender, receiver or intended receiver of the alert, and/or the database(s) that such an alert may be sent from or to, g) and/or any combination of the forgoing and/or any other variable contained in or generally associated with and/or accessible by said alert(s).

In certain embodiments, alerts may only be sent outside the game if the player is not logged into the game.

In certain embodiments, alerts may only be sent in a user specified sequence and/or priority to a number of different notification devices until the player is successfully contacted or otherwise responds.

Alerts may be established using rules and/or severity levels.

The severity of the alert may determine which notification method(s) (if any) are used, e.g., if a price falls by 5% or less, then, send an e-mail message only, if 5% -20% then send a text message, if greater than 20% then send an IM plus all other options, e.g., e-mail and voice mail.

Severity levels may be preset by the game owner or server, or may be adjustable by one or more players or a combination of these methods. In certain embodiments, the severity level may affect when or if an alert is sent and to whom and/or which method of transmission is used. In another embodiment, severity levels may affect which alert information is included with the alert. In yet another embodiment, the severity level may be combined with other information, e.g., alert rules, alert event conditions, game objectives or goals to determine when or if or what type of alert is sent and to whom.

Some alerts may be global alerts, i.e., a message sent to all players or certain classes of players, e.g., the server will be off-line for repairs from midnight tonight to 6 am tomorrow morning, and/or targeted to one or more players, player characters, groups, clans, races, types, etc.

Alerts may permit the user to establish a set amount, ranges, thresholds, trends, percentages, binary (i.e., on/off), and/or rules for any alert condition. Players or applications may also make use of mathematical operands and/or Boolean operators, e.g., If price is 10% greater but not more than 20% greater than X, then send voice mail, else if price is greater than 20% than X, then send instant message and voice mail. Another example might be: if the cost of item A and item B fall below Y, then send alert.

In another embodiment, rules can be established to determine which variables or activities to monitor and what action(s) to take when certain conditions exist or cease to exist or may in the future exist or cease to exist. For example, if player A, purchases item X or any item from group B, then send cell phone text message with the details to cell phone, if Player B or any player from player category A requests a loan, send instant message and e-mail message with details and player information upon the making of the loan request and again upon the consummation of the loan. In one exemplary embodiment of this invention, such rules may be encoded using XML information, parsed by the alert application and acted upon as necessary. In this fashion a system is described that provides substantial flexibility and ease of initial and ongoing maintenance and use of the alerts system for players and or any party authorized to create rules.

In another embodiment, players are charged a fee for the creation or modification of one or more rules and/or for inclusion or exclusion from a rule or group of rules. Or, players may receive an option to create certain alerts or a certain number of alerts for free, and pay only for certain types or only if a certain number greater than a number of free alerts are created and used (or sent).

In another embodiment, a character may be given a reduced alert fee or an alert fee credit for the amount of time he manages NPCs and/or provides other services in the game environment and/or if he creates or defines or registers alerts or alert conditions or alert rules that one or more third party players, applications, games, servers, or other individuals or applications make use of, whether or not such use requires a fee or not.

In another embodiment, one or more virtual businesses and/or players may be created or otherwise authorized that sets up and controls some or all alerts on behalf of the players or any other authorized users. Such entity may or may not charge for some or all of such alerts. Charges for alerts may be for the creation or maintenance and/or the use or activation of such alerts, e.g., one fee for creating the alert rules and another fee (perhaps smaller) for each time the alert is “fired” e.g., used or activated or sent to the player. Fees may be fixed or variable, temporary or permanent. Fees may be based upon the time of or frequency and/or complexity of the alert. E.g., certain “standard alerts” i.e., alerts available to everyone may be free or very inexpensive, while complex alerts with multiple determining factors and/or activities and logic may be more expensive to set up or run or both. In another embodiment, certain alerts may be free for the first use or limited number of uses and then incur a fee for each subsequent use. Such fees may be determined by the game owner, servers, players (via a voting system), or by any affected or otherwise authorized parties. Fees may increase or decrease with use or over time and/or players or other entities may purchase blocks of alerts.

A marketing offer can be made to players from the in game alert service provider. The offer can be made when the player appears to need the alert service, i.e. when his teammates search for him frequently when he is offline, when he is offline more than online, when he is online most of the time, when he is offline most of the time, when he is a member of a guild, and/or when he is a member of a guild that has a certain number of players in it.

The player can specify that certain alerts be blocked during certain activities both inside and outside the game. For example, if the player is on the phone, an alert that would have otherwise been sent to the phone is blocked and queued to be sent later. Alternatively, if a player is involved in a battle in a virtual world, alerts are blocked that are being sent from other virtual worlds. Such blocks may be temporary.

A player can have the option to link his in game chat to an external instant messenger system. When the two are linked the player can talk to other players when he is not logged in to the virtual world, and he can review conversations he had in the game world in his external instant messenger account or within the virtual world.

When one player wants to form a team with other players, the alert system can first invite the potential team member(s) who are logged into the game, then run a query to see if those team members are logged in to an external messenger service and send the invitation to join the team to the external instant messenger system. If the player accepts the team invite from the external instant messenger system, then he can automatically log in to the game directly from the external instant messenger system. For example, clicking on an accept invitation tab in a message may open a browser window, automatically logs the player into the game session, and include the player in the team.

In an embodiment of the present invention, if a recipient of an alert responds to the alert and/or fails to respond, then a second alert (i.e., a subsequent alert) may be generated. In this fashion, alerts may be nested or create a “chain of alerts” that can continue until all recipients respond or take the desired or expected action. In another embodiment, such subsequent alert(s) may be transmitted at a higher or lower severity level and/or have new or additional or less information attached and/or may be transmitted to a different alert output device. For example, if an alert is sent to a player's account indicating that a loan is overdue, and, after 15 days, the player fails to retrieve and/or respond to the alert or otherwise resolve the problem associated with said loan, the alert system may send yet another alert to the player, but increasing the severity, e.g., from 5 to 7 (with 10 being the highest in this case), and send the alert directly to the player's cell phone instead of simply to an in-game messaging system.

Accordingly, system 10 may be configured to perform the various functions described above and may incorporate one or more servers capable of running any number and/or combination of software modules configured to perform various tasks. Exemplary combinations of servers and software modules useful for the presently-described system include:

Game Server
1. Alert Configuration Program
2. Alert Management Program

Alert Management Server
1. Alert Configuration Program
2. Alert Registration Program
3. Activity Tracking Program
4. Alert Management Program
5. Alert Blocking Program
6. Action in Response to Alert Program

Alert Device
1. Receive Alert Program
2. Alert Blocking Program
3. Alert Response Program

System 10 may further include a number of databases configured to store and associate the various types of data that are used by the system to perform the functions described above. Exemplary database architectures useful for the presently-described system include:

| 1. | Player Database | |
|---|---|---|
| | a. | Player ID |
| | b. | Player Personal Info |
| | c. | Player Real Currency Account Information |
| | d. | Player Character Name 1-n |
| | e. | Account created date/time |
| | f. | Characters Owned or Controlled ID 1-n |
| 2. | Player Financial Information Database | |
| | a. | Player ID |
| | b. | Fee Plan/Preferences |
| | c. | Player Billing Information |

| | |
|---|---|
| 1. | Credit Card(s) 1-n |
| 2. | Billing Preference |
| 3. | Account type |
| 4. | Currency Preferences |

| | |
|---|---|
| d. | Player Account Balances 1-n |

| | |
|---|---|
| 1. | Current Amount Due − Total |

| | |
|---|---|
| a. | Details 1-n |

| | |
|---|---|
| i. | Date/Time |
| ii. | Due From ID |
| iii. | Due Amount |
| iv. | Due Currency |
| v. | Terms and Conditions |

| | |
|---|---|
| 2. | Current Amounts Owed − Total |

| | |
|---|---|
| a. | Details 1-n |

| | |
|---|---|
| i. | Date/Time |
| ii. | Owed by ID |
| iii. | Owed Amount |
| iv. | Owed Currency |
| v. | Terms and Conditions |

| | |
|---|---|
| 3. | Financial Transaction History 1-N |

| | |
|---|---|
| a. | Transaction ID |
| b. | Date/Time of Transaction |
| c. | Type |
| d. | Amount |

| 3. | Player Character Database | |
|---|---|---|
| | a. | Character ID |
| | b. | Character Name |
| | c. | Title ID |
| | d. | Character Attributes 1-n |
| | e. | Character Rules 1-n |
| | f. | Virtual Cash Currency Preferences 1-n |
| | g. | Real Cash Currency Preferences 1-n |
| | h. | Virtual Cash Account 1-n |

| | |
|---|---|
| 1. | Account Number 1-n |
| 2. | Account Balance 1-n |

| | |
|---|---|
| i. | Real Cash Account 1-n |

| | |
|---|---|
| 1. | Account Number 1-n |
| 2. | Account Balance 1-n |

| | |
|---|---|
| j. | Credit Card Account 1-n |

| | |
|---|---|
| 1. | Account Number 1-n |
| 2. | Account Balance 1-n |

| | k. | Virtual Item ID 1-n |
|---|---|---|
| 4. | Currency Conversion Database | |
| | a. | Currency ID |
| | b. | Currency Description |
| | c. | Usage Rules 1-n |
| | d. | Exchange Rate/Date 1-n |
| | e. | Exchange Fees 1-n |
| 5. | Player Character Activity Database | |
| | a. | Player Character Name/ID 1-n |
| | b. | Date/Time/Duration of Activity |
| | c. | Activities 1-n |

| | |
|---|---|
| 1. | Activity Name |
| 2. | Activity Type |
| 3. | Quantity 1-N |
| 4. | Quality |
| 5. | Narrative/Additional Info 1-N |
| 6. | Outcomes 1-N |

| 6. | Tax Rule Rate Database | |
|---|---|---|
| | a. | Tax Rule ID 1-N |

| | |
|---|---|
| 1. | Applies To - Item/Activities IDs 1-n |

| | |
|---|---|
| a. | Application Rules 1-N |

| | |
|---|---|
| i. | Tax Name |
| ii. | Tax Method |
| iii. | Tax Rate |
| iv. | Default Currency |

| 7. | Franchisee Database | |
|---|---|---|
| | a. | Franchisee ID 1-N |

| | |
|---|---|
| 1. | Name |
| 2. | Player, Character or other Owner Ids 1-n |
| 3. | Ownership Percentages |
| 4. | Personal Information |
| 5. | Terms and Conditions |
| 6. | Financial Data |

| | |
|---|---|
| a. | Billing Information |
| b. | Currency Preferences |
| c. | Payment Terms |
| d. | Revenue Sharing Terms |

| 8. | Virtual Transaction Database | |
|---|---|---|
| | a. | Transaction ID |

| | |
|---|---|
| 1. | Date/Time |
| 2. | Type of Transaction |
| 3. | Player ID 1-n |

| | |
|---|---|
| a. | Character ID 1-n |
| b. | Title ID 1-n |

| | |
|---|---|
| 4. | Third Party ID 1-n |
| 5. | Franchisee/or other ID 1-n |
| 6. | Financial Data |

| | |
|---|---|
| a. | Bill To ID, Date & % 1-n |
| b. | Bill From ID, Date & % 1-n |

| | |
|---|---|
| 7. | Terms Data |

| | |
|---|---|
| a. | Creation/Use Rules |
| b. | Payment Terms |
| c. | Interest Terms |
| d. | Penalty Terms |

| | |
|---|---|
| 8. | Item ID 1-n |

| | |
|---|---|
| a. | Item Title ID 1-n |

| | |
|---|---|
| 9. | Other Transaction Data (varies based on transaction type) |

| 9. | Virtual Item Database | |
|---|---|---|
| | a. | Item ID |
| | b. | Item Title ID |
| | c. | Item Description |
| | d. | Free Form Notes 1-n |
| | e. | Item Attributes 1-n |
| | f. | Item Rules (i.e., construction, use, disposal, restrictions, etc.) - |
| | | 1-n |
| | g. | Financial Information |

| | |
|---|---|
| 1. | Original Cost |
| 2. | Original Currency Type |
| 3. | Improvements 1-n |
| 4. | Lifespan |
| 5. | Health |
| 6. | Damage |
| 7. | Depreciation |
| 8. | Current Value |
| 9. | Current Value Currency Type |
| 10. | Liens 1-n |
| 11. | Loans 1-n |

| 10. | Virtual Title Database | |
|---|---|---|
| | a. | Item Title ID |
| | b. | Item ID |
| | c. | Original Creator/Player ID and Ownership % 1-n |
| | d. | Created Date |
| | e. | Current Owner/Player ID and Ownership % 1-n |
| | f. | Manifest Data |

| | |
|---|---|
| 1. | All Previous Owners/Player IDs (1-N) |
| 2. | Original Ownership Percentages 1-n |
| 3. | Remaining ownership interest percentages |
| 4. | Remaining Liens/Loans outstanding 1-n |

Exchange Server
1. Currency Conversion Database
   a. Currency ID
   b. Currency Description
   c. Usage Rules 1-n
   d. Exchange Rate/Date 1-n
   e. Exchange Fees 1-n
2. Fee Database
   a. Fee ID
   b. Fee Description
   c. Fee Amount/Calculation Method
   d. Fee Usage Rules 1-n

Real World Billing Account Server

| a. | Player Account Database | |
|---|---|---|
| | 1. | Player ID |
| | 2. | Player Personal Info |
| | 3. | Player Real Currency Account Information |
| | 4. | Player Financial Account Information |
| | 5. | Player Games Played Id 1-n |

| | |
|---|---|
| a. | Player Character Name 1-n |

| | |
|---|---|
| i. | Account created date/time |
| ii. | Characters Owned or Controlled ID 1-n |

| | |
|---|---|
| 1. | Player Billing Information |

| | |
|---|---|
| a. | Credit Card(s) 1-n |
| b. | Billing Preference |
| c. | Account type |
| d. | Currency Preferences |

| | |
|---|---|
| 2. | Player Account Balances 1-n |

| | |
|---|---|
| a. | Current Amount Due − Total |

| | |
|---|---|
| i. | Details 1-n |
| ii. | Date/Time |
| iii. | Due From ID |
| iv. | Due Amount |
| v. | Due Currency |
| vi. | Terms and Conditions |

| | |
|---|---|
| b. | Current Amounts Owed − Total |

| | |
|---|---|
| i. | Details 1-n |

| | |
|---|---|
| 1. | Date/Time |
| 2. | Owed by ID |
| 3. | Owed Amount |
| 4. | Owed Currency |
| 5. | Terms and Conditions |

| | |
|---|---|
| c. | Financial Transaction History 1-N |

| | |
|---|---|
| i. | Transaction ID |
| ii. | Date/Time of Transaction |
| iii. | Type |
| iv. | Amount |

Game Server Franchisee Server
1. Franchisee Database
   a. Franchisee ID Number
   b. Franchisee Name
   c. Franchisee Billing Information
   d. Games Supported 1-N
   e. Servers Supported 1-N
2. Activity Database
   a. Activity ID
      1. Time/Date
      2. Transaction Type
      3. Amount
      4. Description
      5. Game ID
      6. Server ID
3. Player Character Database
   a. Character ID
   b. Character Name
   c. Title ID
   d. Character Attributes 1-n
   e. Character Rules 1-n
   f. Virtual Cash Currency Preferences 1-n
   g. Real Cash Currency Preferences 1-n
   h. Virtual Cash Account 1-n
      1. Account Number 1-n
      2. Account Balance 1-n
   i. Real Cash Account 1-n
      1. Account Number 1-n
      2. Account Balance 1-n
   j. Credit Card Account 1-n
      1. Account Number 1-n
      2. Account Balance 1-n
   k. Virtual Item ID 1-n
4. Currency Conversion Database
   a. Currency ID
   b. Currency Description
   c. Usage Rules 1-n
   d. Exchange Rate/Date 1-n
   e. Exchange Fees 1-n
5. Player Character Activity Database
   a. Player Character Name/ID 1-n
   b. Date/Time/Duration of Activity
   c. Activities 1-n
      1. Activity Name
      2. Activity Type
      3. Quantity 1-N
      4. Quality
      5. Narrative/Additional Info 1-N
      6. Outcomes 1-N
      6. Player Alert Database
   a. Player ID
   b. Player Character ID 1-N
      1. Alert ID 1-N
         a. Description
         b. Alert Type ID
         c. Alert Event Conditions
         d. Alert Rules
         e. Alert Output Device
         f. Alert Output Data
7. Alert Fee Database
   a. Alert Type ID
   b. Description
   c. Fee Type
   d. Fee Amount
   e. Duration/Frequency

Alert Management Server

| | |
|---|---|
| 1. | Player Database (see above) |
| 2. | Player Character Database (see above) |
| 3. | Player Activity Database (see above) |
| 4. | Player Alert Database (see above) |
| 5. | Alert Log |

| | |
|---|---|
| a. | Alert Transaction GUID 1-N |

| | |
|---|---|
| 1. | Alert Event ID 1-N |
| 2. | Alert transaction details 1-n |

| | |
|---|---|
| a. | Description |
| b. | Type |
| c. | Date/Time |
| d. | Source (game, device, database, player, etc.) |
| e. | Destination (game, device, database, player, |
| | etc.) |
| f. | Amount (quantity) |
| g. | Currency amount |
| h. | Alert Variable (pre-alert value) |
| i. | Alert Variable (post-alert value) |
| j. | Method of calculation or rule |

6. Other Databases—It will be readily apparent to anyone skilled in the art to understand that any other data or information made available to the alerts system could be tapped to drive additional alert conditions/events/criteria.

Accordingly, a system such as that described herein will be configured to perform various functions, such as those described above, by performing various method steps in order to accomplish one or more given tasks. Non-limiting examples of programs or modules that may be employed by a system according to the present disclosure include the following programs which may have the following architectures and/or capabilities:

Alert Management Server
1. Open Databases
2. Create/Define Alerts
3. Register Alerts
4. Monitor System Activities, Events, Databases
5. Determine or receive an indication that an Alert Event has or will occur
6. Determine if an action should be performed if an alert event occurs

Determine if an Alert Should Be Transmitted and to whom
1. Send/Display/Record Alert (if and as applicable)
2. Determine fees (if any) for the alert
3. Charge fee for alert (if applicable)
4. Execute Revenue Sharing Program (if applicable)
5. Execute Currency Conversion Program (if applicable)
6. Update Databases

According to another embodiment, the present disclosure provides improved virtual credit scores for player characters of a massive multi player online game. According to this embodiment, a player creates a character account in a MMPOG. The activities of the character are monitored and each activity is assigned a positive or negative credit score point or a fraction thereof or one or more positive or negative credit score points or a fraction thereof may be added or subtracted to/from the current score. At the end of each gaming session, or in real time, or at any other designated or periodic intervals, credit score points for the player character are tallied to generate a credit score or a revised credit score. The player character credit score may be used, in part or in whole, to establish the virtual credit worthiness of the player character for financial, contractual and/or other aspects of the game.

Activities that can be assigned credit score points and/or that may change a credit score may be based upon any one or more of the following including, but not limited to the real or virtual:
1. time a player or character account has been active or inactive
2. number of complaints or compliments by other players/characters for a given player/character
3. amount of time and/or quality and/or number of times a player or player character has provided assistance or other help or tutelage to another player and/or player character
4. amount of time and/or quality and/or number of times a player or player character spends managing, directing or otherwise controlling one or more NPC's
5. attributes and virtual assets or debts of the player/character
6. player or character total or frequency of purchases of virtual cash outside or within the game environment
7. number of loans and contracts that the character has outstanding and/or their balances
8. payment history and timeliness of payments for any loans or other payment obligations, e.g., tax or other fee payment history
9. guild or family of the player or character
10. number of times the character has defaulted or paid timely on a loan or other contract
11. age of the player account
12. age of the player
13. real world credit scores, points, creditworthiness or payment history
14. experience level of the player or one or more of his characters
15. annual income of the player or one or more of his character
16. payment history of the character
17. production level of the character, e.g., ability or historical performance in producing objects within the game
18. Current assets or liabilities, e.g., net worth of a player character
19. The number of active characters in a player account
20. The size of the character's guild or family in the game environment
21. The age of the account of the player
22. The virtual transaction volume of the character or player
23. Membership status of the character, e.g., premium member vs. basic member of the video game or credit card holder status, e.g., gold or platinum members
24. Age of the video game or credit card account,
25. Killing monsters in a game environment
26. Joining a Guild in a game environment
27. Completing a quest in a game environment
28. Solving or completed a game parameter in a game environment
29. Paying a bill timely
30. Failure to pay a bill when due
31. Randomly
32. Any activity or outcome within the game or associated with the player's and/or the any one or more of the player character's financial condition (real or virtual) and/or the credit card(s) and/or credit line(s)
33. How many times the player or player character requests credit or such credit is checked or held or is otherwise encumbered
34. A range of amounts or values or reaching or falling below a threshold associated with any of the above (as appropriate)
35. An alert event
36. The achievement or failure to achieve or based upon any one or more game objectives or goals.
37. A change in any one or more of the preceding and/or a change in a trend associated with any of the above
38. Any combination of any or all of the above, which are hereafter referred to individually and/or collectively as a “credit score modification event.”

Credit Scores could be determined:
1. By summing all the credit score points
2. By averaging all the credit score points
3. By using a weighted average of the credit score points, i.e., weighting certain of the activities greater or less than other such activities, e.g., an actual virtual cash balance may be weighed more heavily than certain virtual assets that are not as liquid.
4. Using any existing or well known credit scoring algorithms, such as those used by existing credit scoring agencies such as Equifax.
5. Or any other combination or scoring method or other mathematical calculation.

According to a further embodiment, players who do not pay back loans or do not pay on time or do not pay the full amount as or when due, and/or otherwise fail to perform as or when required may be assigned a new or different/revised credit score. Player characters that have a generally higher amount of debt in total or as a ratio of debt to assets or other liquidity metrics and/or make timely payments as and when due, and in full, may have a new or different credit score assigned. Credit scores may affect (positively or negatively) interest rates, penalties and/or agreement terms and conditions, or end of term options on current or subsequent loans by lending institutions, businesses, credit providers, NPCs or other player characters or any other lending entity.

According to a further embodiment, one character's credit score may have an effect on the credit scores of other characters controlled by that player.

In certain embodiments within certain games, one or more players or their character(s) may be able to modify a credit score, e.g., via a credit score potion or curse, or via any authorized method, e.g., a given player may be granted authority to make such changes.

In addition, or in the alternative, certain games may permit the game owner or a council of players to have such authority over virtual credit scores.

Based upon the occurrence of one or more credit score modification events, the player character may suffer from one or more of the following penalties including, but not limited to temporary or permanent: restrictions to play the game or part of the game, damage or other loss to an item, player character, points awarded, restricted access to, or use of or partial loss of any assets, items, game space, missions, characters, avatars, skills, communications abilities, etc., or temporary or limited play, such as slower character movement (or speed of communications) or response times, limited access to services or income, e.g., a garnishing of wages until the tax debts (plus interest if any) are collected in part or in full, artificial “lag” imposed on the player or the player character(s) of the player, or any other penalties or restrictions determined by the game owner, game server or any other authorized entity, e.g., an elected official, body, bank, agency, etc. Third parties can rent server space from the game provider and provide this structure to other players in the game. In one embodiment, the game server may charge a monthly virtual or real fee to the third party or other player, who then sells play time on the game server to other players. All or part of the fees paid can be in virtual or real dollars, that are secured with a real world credit card that is charged if the virtual fees collected in a given month are not adequate to cover the specified monthly fee. Any one or more of the preceding may be referred to as a “credit score penalty.”

In addition or in the alternate, credit score changes in the virtual world may have an affect on real world credit scores and/or the player may suffer one or more of the preceding penalties within the real world (where and if applicable).

According to an embodiment, games or players may establish rules and conditions under which a player may declare bankruptcy. The effect of a bankruptcy may be the imposition of any one or more of the following options/penalties, including but not limited to:
1. Temporary or Lifetime banishment from the game
2. A required repayment of part or all debts owed and/or interest and/or penalties to those who suffered from the bankruptcy
3. A flag may be set to require virtual or cash payments to continue play, plus some additional (optional) amount which will payoff the outstanding debt over time along with any additional fines or other penalties and interest
4. A complete or partial, temporary or permanent, forgiveness of debts.
5. A charge for all or part of the indebtedness to the player's credit card.
6. A change to a player character's avatar or account.
7. A change to a player or player character's real or virtual credit file or credit score, and/or
8. The imposition of one or more credit score penalties.

According to some embodiments, real debts are less likely to be partially or completely forgiven, whereas artificial debts may be more easily relieved, partially or fully expunged. Courts or member panels (i.e., juries) may be used to decide the fate of anyone declaring bankruptcy and alter or replace any or all of the above rules, if such court or panel is so empowered.

Virtual credit scores can be contested in virtual court. The virtual court can elect to change the credit score of the player. The court can be held by Player Characters or Non Player Characters.

According to an embodiment, players who interact with the player can assign a credit score vote to that player. Each player is given the opportunity to assign a credit score to a player they interact with. The actual credit score of the player is determined, in part, by averaging the scores assigned to him by other players.

In some embodiments, killing monsters or completing other game parameters can have an effect on the player's credit score. Every time a game parameter is completed, the player's credit score is given additional positive credit. If a player fails to complete a game parameter, his credit score could be diminished.

According to one embodiment, players can pay a real or virtual world fee to improve their virtual credit score and/or instead of suffering a credit score penalty. Each point of the virtual credit score can have a virtual and real world cash value. This value can be unique to each player character based on their risk profile and credit history. Players can also opt to provide services or assistance to other players instead of or in addition to paying a fee.

In an embodiment, the game server generally tracks some or all of the activity of a player and/or player character(s) in a game environment and creates a credit history and risk profile based on the activity. A score is generated from this credit history and risk profile.

The system can generate a list of services, behaviors or missions that a player character can perform in order to improve their credit score. If and when the player performs the tasks necessary to improve the score, the system can adjust the score accordingly.

The credit scores of players or player characters can be exported from the game and published on a server where real or virtual credit lenders can use them to make credit offers to customers and/or to make other decisions, e.g., determining an appropriate interest rate and/or other terms and conditions, e.g., determining a length for a new loan.

Credit Scores can be changed by the occurrence of any one or more credit score modification event(s).

In certain embodiments of the present invention, when or if a credit score has, does, or is expected to change or does not change, the affected player, player character and/or any other affected parties may be notified of such score change or absence of change via an Alert, such as those described above. For example, the system might alert a player that an unpaid tax is or will be coming due that may affect his credit score. In another embodiment, the system might alert a first player that the failure of a second player to pay a debt secured by said first player is coming due and such failure to pay may affect said first player's credit score, giving said first player an opportunity to encourage or force said second player to pay said second player's outstanding amounts when due and/or to permit said first player the opportunity to pay said second player's debt so as to avoid any negative changes or impact on said first player's real or virtual credit score.

The activity of every player character in a player account can have an effect on the total credit score of a player. Each character type can have a different set of rules and conditions for generating a credit score. For instance, a character type “thief” could receive high credit score points for stealing, while a character type “warrior” could receive low credit score points for stealing. Credit score points are given based on the quality of activity of a character for that character's type.

Accordingly, system 10 may be configured to perform the various functions described above and may incorporate one or more servers capable of running any number and/or combination of software modules configured to perform various tasks. Exemplary combinations of servers and software modules useful for the presently-described system include:

Game Environment Server
1. Credit History Program
2. Game Program
3. Risk Profile Program
4. Credit Score Improvement Determination Program
5. Credit Score Program
6. Court Program

Credit Score Server
1. Credit History Program
2. Risk Profile Program
3. Credit Score Program

Financial Obligation Server
1 Determine Appropriate Credit To offer Program

Issue Credit Program
1. Credit Payment Program

System 10 may further include a number of databases configured to store and associate the various types of data that are used by the system to perform the functions described above. Exemplary database architectures useful for the presently-described system include:

Game Server
1. Player Database
   a. Player ID
   b. Player Personal Info
   c. Player Billing Info
   d. Player Real World Credit Score
   e. Player Virtual World Credit Score
   f. Player Character 1-n
2. Player Character Database
   a. Character ID
   b. Character Attributes 1-n
   c. Transaction History
   d. Virtual Credit Score
   e. Activity History
   f. Title ID 1-n
   g. Type ID 1-n
   h. Family ID 1-n
   i. Guild ID 1-n
3. Player Activity Database
   a. Player ID
   b. Player Character ID
   c. Activity ID
   d. Activity Date
   e. Activity Descriptor
   f. Activity Play Log (Video, Audio, Code)
4. Player Credit History Database
   a. Credit ID
   b. Credit Date
   c. Credit Score
5. Player Risk Profile Database
   a. Risk ID
   b. Risk Score
   c. Total Risk Score
6. Player Credit Score Database
   a. Score Qualifier 1-n
   b. Score Amount
   c. Score Descriptor
   d. Total Score
7. Player Relationship Database
   a. Relationship ID
   b. Relationship Type
   c. Player ID 1-n
8. Credit Score Conditions Database
   a. Condition ID
   b. Condition Descriptor
   c. Condition Value 1-n
   d. Character Type 1-n
   e. Player Type 1-n
   f. Player relationships 1-n
9. Transaction Database
   a. Transaction ID
   b. Transaction Type
   c. Player ID 1-n
   d. Character ID 1-n
   e. Merchant ID 1-n
   f. Game Server ID
   g. Exchange ID 1-n
   h. Jurisdiction ID 1-n
   i. Financial Institution ID 1-n
   j. Item ID 1-n
   k. Item Price 1-n
   l. Finance offer 1-n
   m. Purchase Total
10. Court Ruling Database
   a. Court Case ID
   b. Player ID 1-n
   c. Player Type 1-n
   d. Activity 1-n
   e. Case Descriptor
   f. Case Type
   g. Activity Type 1-n
   h. Ruling Type
   i. Ruling Descriptor
11. Risk Profile Conditions Database
   a. Condition ID
   b. Condition Type
   c. Condition Descriptor
   d. Actions 1-n

Credit Score Server
1. Credit Score Conditions Database-stores the activities possible with outcomes and player or player character behavior. Also store the conditions that can be applied to these behaviors to generate all or a component of a credit score for a player character or player.
2. Player Credit History Database-stores the transaction and activity history of a player or player character, along with corresponding credit scores.
3. Risk Profile Conditions Database-stores the risk profile of a player or player character based on transaction and activity history.
4. Score Improvement Database-stores rules and conditions for activity that can improve a credit score based on a player type, player character type, and activity of a player or player character

Financial Obligation Server
1. Player Database
   a. Player ID
   b. Player Credit Score
   c. Player Credit History
   d. Player Risk Profile
2. Credit Offers Database
   a. Offer ID
   b. Player Condition 1-n
   c. Offer terms and conditions
3. Credit Conditions Database
   a. Condition ID
   b. Condition Descriptor
   c. Condition Limitations

Accordingly, a system such as that described herein will be configured to perform various functions, such as those described above, by performing various method steps in order to accomplish one or more given tasks. Non-limiting examples of programs or modules that may be employed by a system according to the present disclosure include the following programs which may have the following architectures and/or capabilities:

Game Server
1. Generate Virtual Credit History
   a. Retrieve player or player character activity
   b. Generate credit history based on rules and conditions
   c. Store Credit History with player account
2. Generate Virtual Risk Profile
   a. Retrieve player or player character Credit History
   b. Generate risk profile based on credit history and rules and conditions
   c. Store risk profile with player account
3. Generate Credit Score
   a. Retrieve player or player character activity
   b. Generate Credit Score based on activity and rules and conditions
   c. Store credit score with player account
4. Vote on Other Player's Credit Score
   a. Receive a request to vote on a player or player character credit score including an id
   b. Output vote form
   c. Receive credit score vote
   d. Store credit score vote
   e. Apply vote to player or player character score
   f. Update credit score with applicable info from vote
5. Overrule Credit Score
   a. Receive a request to overrule a credit score, including evidence
   b. Determine if evidence adequately overrules credit score
   c. Adjust credit score if evidence adequately overrules credit score
6. Refresh Credit Score
   a. Retrieve credit score
   b. Retrieve activity since credit score was generated
   c. Determine credit score modification based on activity
   d. Adjust credit score based on modification
   e. Store refreshed credit score
7. Refresh Virtual Credit History
   a. Retrieve credit history
   b. Retrieve activity since credit history was generated
   c. Determine credit history modification and additions based on activity
   d. Adjust credit history based on modification and addition
   e. Store refreshed credit history
   f. Refresh Virtual Risk Profile
8. Retrieve risk profile
   a. Retrieve activity since risk profile was generated
   b. Determine risk profile modification based on activity
   c. Adjust risk profile based on modification
   d. Store refreshed risk profile
9. Determine and Output Ways to Improve Credit Score
   a. Retrieve credit score of a player or player character
   b. Generate credit score improvement list based on rules and conditions
   c. Output improvement list to player or player character
10. Publish Player Character Credit Scores
   a. Retrieve Player Credit Scores
   b. Compile Credit Scores
   c. Output Compiled Credit Scores (via web posting, email, or other alert method)

Credit Score Server
1. Generate Credit Score
   a. Receive player or player character activity
   b. Generate Credit Score based on activity and rules and conditions
   c. Store credit score with player account
2. Publish Credit Score
   a. Retrieve Player Credit Scores
   b. Compile Credit Scores
   c. Output Compiled Credit Scores (via web posting, email, or other alert method)
3. Update Credit Score
   a. Retrieve credit score
   b. Retrieve activity since credit score was generated
   c. Determine credit score modification based on activity
   d. Adjust credit score based on modification
   e. Store updated credit score
4. Determine and Output Ways to Improve Credit Score
   a. Retrieve credit score of a player or player character
   b. Generate credit score improvement list based on rules and conditions
   c. Output improvement list to player or player character

Financial Obligation Server
1. Generate Credit Offers
   a. Receive a credit score, credit history, activity, and/or risk profile of a player or player character
   b. Determine appropriate credit offer by applying rules and conditions to player information
   c. Store credit offer
   d. Output offers to appropriate third party servers
2. Output Credit Offers
   a. Receive a request for a credit offer including a merchant ID, player id, transaction information, and game server information
   b. Retrieve or generate credit offers
   c. Output Credit offers
3. Create Credit Accounts
   a. Receive an acceptance of a credit offer
   b. Create new credit account based on data generated in credit offer acceptance.

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
providing a virtual environment in which players can interact with each other via player characters;
providing a user-interface through which players can interact with the virtual environment; and
receiving a request from a player to deliver an alert to the player upon the occurrence of one or more events in the virtual environment.

2. The method of claim 1 further comprising:
identifying the occurrence of the one or more events; and
sending a first alert to the player.

3. The method of claim 1 further comprising receiving a fee from the player.

4. The method of claim 3 wherein the fee is paid at the time of the request.

5. The method of claim 3 wherein the fee is paid by the player after the player receives the alert.

6. The method of claim 1 wherein the event is an impending payment due date.

7. The method of claim 2 further comprising:
determining that the player has not engaged in a predetermined response to the alert; and
sending a second alert to the player.

8. The method of claim 7 wherein the delivery mechanism of the first alert is different from the delivery mechanism of the second alert.

9. The method of claim 8 wherein the first alert is delivered to a game account associated with the player.

10. The method of claim 9 wherein the second alert delivery mechanism is a real world communication device.

11. The method of claim 10 wherein the real world communication device is selected from the group consisting of: a cell phone, a pager, and a text message-enabled handheld device.

12. The method of claim 1 further comprising providing a user interface wherein a player can indicate one or more preferences related to the alert.

13. The method of claim 12 wherein the preferences comprise the mechanism of delivery.

14. The method of claim 12 wherein the preferences comprise the in-game events to which the player would like to be alerted.

15. The method of claim 2 further comprising:
determining if the player is logged into the game; and
if the player is logged into the game, sending the alert via a first delivery mechanism and
if the player is not logged into the game, sending the alert via a second delivery mechanism.

16. The method of claim 15 wherein the first delivery mechanism is an in-game delivery mechanism.

17. The method of claim 16 wherein the in-game delivery mechanism is detectable to the player via the player's user interface with the virtual environment.

18. The method of claim 15 wherein the second delivery mechanism is a real world communication device that is detectable to the player outside of the player's user interface with the virtual environment.

19. The method of claim 18 wherein the real world communication device is a cell phone.

20. The method of claim 3 further comprising:
determining if the player has provided services in the game environment; and
reducing the fee if the player has provided services in the game environment.
